(19) United States
(12) Patent Application Publication
(10) Pub. No.: US 2013/0011298 A1
(43) Pub. Date: Jan. 10, 2013

(54) SAMPLE ANALYZER AND STORAGE MEDIUM

(76) Inventors: Kenichi Itou, Kobe-shi (JP); Naoki Shindo, Palatine, IL (US); Noriyuki Saito, Kobe-shi (JP)

(21) Appl. No.: 13/542,890

(22) Filed: Jul. 6, 2012

(30) Foreign Application Priority Data
Jul. 7, 2011 (JP) JP2011-150853

(51) Int. Cl. G01N 21/75

(52) U.S. Cl. 422/73

(57) ABSTRACT

A sample analyzer comprising: a measurement unit configured to perform, by using a reagent, a quality control measurement for measuring a quality control specimen; a display; and a controller configured to control the display to show reagent information for verifying a state of the reagent used in the quality control measurement, in conjunction with a result of the quality control measurement obtained by the measurement unit.

### RELATED APPLICATIONS

This application claims priority under 35 U.S.C. §119 to Japanese Patent Application No. 2011-150853 filed on Jul. 7, 2011, the entire content of which is hereby incorporated by reference.

### BACKGROUND OF THE INVENTION

1. Field of the Invention

The present invention relates to a sample analyzer that analyzes samples such as blood and urine, and a storage medium used for processing relating to such sample analysis.

2. Description of the Related Art

Conventionally, in order to ensure the reliability of a sample analysis result obtained in a sample analysis, a quality control in which a quality control specimen is measured by a sample analyzer is performed. The quality control specimen is a specimen having a known concentration, and when a measurement result of the quality control specimen is in a normal range, it is determined that the sample analyzer that performed the measurement is functioning normally.

For example, Japanese Laid-open Patent Publication No. 2008-58129 discloses an automatic analyzer that can show a display of a measurement result of a quality control specimen, from a sample measurement result screen. In the automatic analyzer disclosed in Japanese Laid-open Patent Publication No. 2008-58129, measurement results of a plurality of analysis items for each sample can be displayed on the measurement result screen. On the measurement result screen, an analysis item can be selected with a cursor, and when an input is performed on a detailed information button, a screen that indicates analysis information (information necessary to analyze a cause when an abnormality has occurred in a measurement result) of the selected analysis item is displayed. The analysis information includes: the reagent lot, the reagent bottle size, and expiration date information of a reagent used in the specimen measurement; the date on which calibration was performed; and a result and the date and time of the measurement performed on the quality control specimen.

Even when a measurement of a quality control specimen is appropriately performed by a normally-functioning sample analyzer, results of the quality control measurement vary depending on the state (such as a deterioration state) of the reagent used in the measurement. Therefore, in order to appropriately determine whether a sample analyzer that performed a measurement is functioning normally, it is desired that the state of a reagent used in a quality control measurement can be verified.

In the above automatic analyzer disclosed in Japanese Laid-open Patent Publication No. 2008-58129, the date and time of the measurement are displayed in conjunction with the results of the quality control measurement. However, in order to verify the state of the reagent used in the quality control measurement, the user needs to search himself or herself information of the reagent used in the quality control measurement, which imposes a great burden for the user.

The present invention has been made in view of the above situation. A main object of the present invention is to provide a sample analyzer and a storage medium that allow easy verification of the state of a reagent used in a quality control measurement and that allow easy clarification of the cause of variation of results of the quality control measurement.

### SUMMARY OF THE INVENTION

The scope of the present invention is defined solely by the appended claims, and is not affected to any degree by the statements within this summary.

According to the sample analyzer and the storage medium of the present invention, it is possible to easily verify the state of a reagent used in a quality control measurement and to easily clarify a cause of variation of results of the quality control measurement.

A first aspect of the present invention is a sample analyzer comprising: a measurement unit configured to perform, by using a reagent, a quality control measurement for measuring a quality control specimen; a display; and a controller configured to control the display to show reagent information for verifying a state of the reagent used in the quality control measurement, in conjunction with a result of the quality control measurement obtained by the measurement unit.

A second aspect of the present invention is a sample analyzer comprising: a measurement unit configured to perform, by using a reagent, a sample measurement for measuring a sample of a subject, and to perform, by using a reagent, a quality control measurement for measuring a quality control specimen; a display; and a controller configured to: control the display to show a sample measurement result screen for showing a measurement result of the sample of the subject measured by the measurement unit, and control, upon receiving a predetermined instruction through the sample measurement result screen, the display to show reagent information for verifying a state of a reagent used in a quality control measurement performed before obtainment of the measurement result being shown on the sample measurement result screen.

A third aspect of the present invention is a sample analyzer comprising: a measurement unit including a setting section in which a reagent container containing a liquid reagent prepared by diluting a freeze-dried reagent with a predetermined liquid is set, and configured to perform, by using the liquid reagent in the reagent container set in the setting section, a measurement of a quality control specimen; a display; and a controller configured to control the display to show a lot number of the reagent used in the measurement of the quality control specimen and identification information of the reagent container in which the liquid reagent was contained, in conjunction with a result of the measurement of the quality control specimen obtained by the measurement unit.

A forth aspect of the present invention is a non-transitory storage medium having stored therein computer-executable programs executed by at least one processor of a sample analyzer to: obtain a measurement result of a quality control specimen measured by a measurement unit by using a reagent; and show reagent information to a display for verifying a state of the reagent used in the measurement of the quality control specimen, in conjunction with the measurement result of the quality control specimen.

A fifth aspect of the present invention is a non-transitory storage medium having stored therein computer-executable programs executed by at least one processor of a sample analyzer to: obtain a measurement result of a sample of a subject measured by a measurement unit by using a reagent; show a sample measurement result screen to a display for showing the measurement result of the sample; and show, upon receiving a predetermined instruction through the sample measurement result screen, reagent information to the display for verifying a state of a reagent used in a measurement of a quality control specimen performed by the measurement unit before obtaining the measurement result being displayed on the sample measurement result screen.

### BRIEF DESCRIPTION OF THE DRAWINGS

FIG. 1 is a perspective view showing a configuration of a sample analyzer according to an embodiment;

FIG. 2 is a plan view showing a schematic configuration of a measurement unit included in a sample analyzer according to an embodiment;

FIG. 3 is a block diagram showing a configuration of an information processing unit included in a sample analyzer according to an embodiment;

FIG. 4 is a schematic diagram showing a configuration of a reagent information data base;

FIG. 5 is a schematic diagram showing a configuration of an analysis result data base;

FIG. 6 is a schematic diagram showing a configuration of a quality control data base;

FIG. 7 is a schematic diagram showing a configuration of a calibration curve data base;

FIG. 8 is a flow chart showing steps of a reagent information registration operation performed by a sample analyzer according to an embodiment;

FIG. 9A is a flow chart showing steps of a measuring operation performed by a sample analyzer according to an embodiment;

FIG. 9B is a flow chart showing steps of a measuring operation performed by a sample analyzer according to an embodiment;

FIG. 10 is a flow chart showing steps of a quality control result displaying operation performed by a sample analyzer according to an embodiment;

FIG. 11 shows an example of a quality control chart screen;

FIG. 12 shows an example of a quality control information dialog;

FIG. 13 shows an example of a calibration curve information dialog;

FIG. 14A is a flow chart showing steps of a sample analysis result displaying operation performed by a sample analyzer according to an embodiment;

FIG. 14B is a flow chart showing steps of a sample analysis result displaying operation performed by a sample analyzer according to an embodiment;

FIG. 15 shows an example of a job list screen; and

FIG. 16 shows an example of a detailed analysis result screen.

### DETAILED DESCRIPTION OF THE PREFERRED EMBODIMENTS

The preferred embodiments of the present invention will be described hereinafter with reference to the drawings.

### [Configuration of a Sample Analyzer]

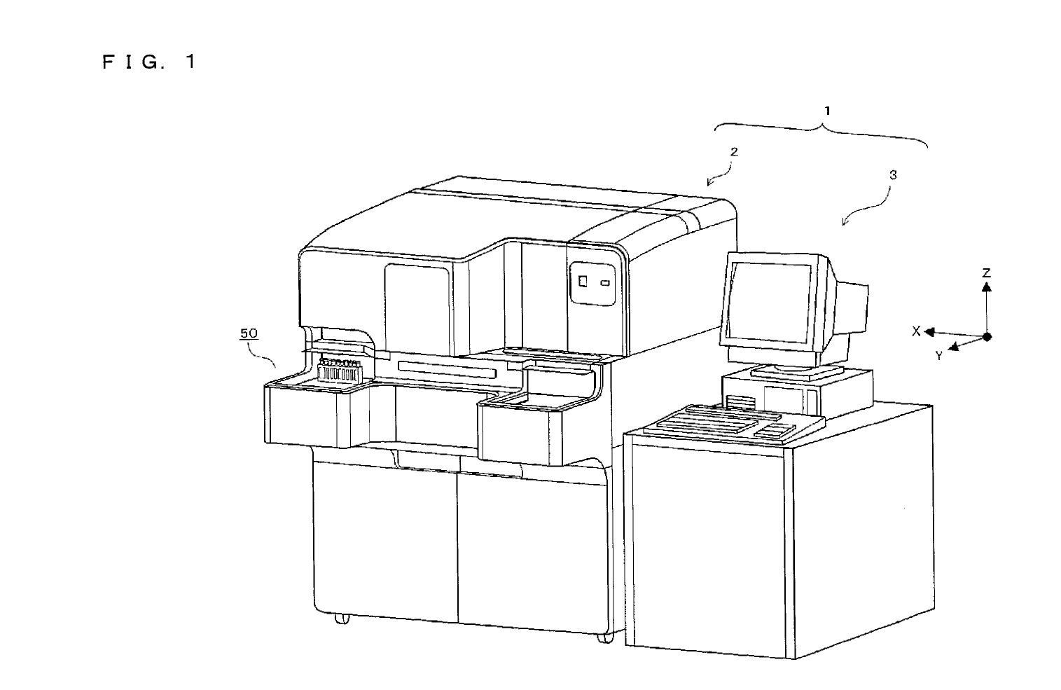

FIG. 1 is a perspective view showing a configuration of a sample analyzer 1 according to the present embodiment. The sample analyzer 1 is a blood coagulation analyzer for analyzing the coagulation function of blood of a subject, and includes a measurement unit 2 that performs optical measurement on components contained in a sample (blood) of a subject, and an information processing unit 3 that obtains an analysis result of a sample by processing data of the measurement performed by the measurement unit 2, and that provides an operation instruction to the measurement unit 2.

### [Configuration of the Sample Analyzer]

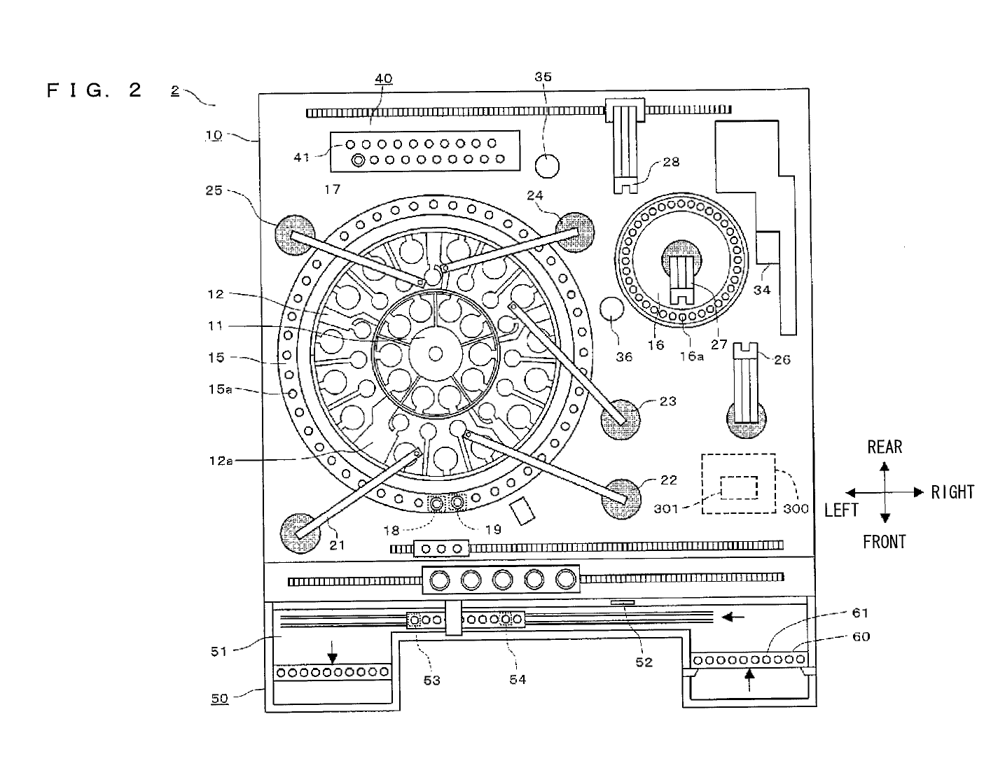

FIG. 2 is a plan view showing a schematic configuration of the measurement unit 2. The measurement unit 2 includes a first reagent table 11, a second reagent table 12, a cuvette table 15, a heating table 16, a table cover 17, sample dispensing units 21 and 22, reagent dispensing units 23 to 25, catcher units 26 to 28, a cuvette supply port 34, disposal holes 35 and 36, a detection unit 40, and a transporting unit 50.

Each of the first reagent table 11, the second reagent table 12, the cuvette table 15 and the heating table 16 is a circular table, and is independently rotationally driven in both clockwise and counter-clockwise directions. These tables are rotationally driven by a plurality of stepping motors (not shown) provided on the rear surface of the bottom of the measurement unit.

Holders for holding reagent containers are formed in the top surfaces of the first reagent table 11 and the second reagent table 12.

The sample analyzer 1 can perform a sample analysis for a plurality of analysis items. Reagents corresponding to analysis items are set on the first reagent table 11 and the second reagent table 12.

A usable life is set for each reagent, and when the remaining amount of a reagent runs short, or when its usable life has passed, the reagent is replaced by the user. A barcode label is attached to each reagent container, and on the barcode label, printed is a bar code that indicates reagent information of the reagent, such as reagent name, lot number, reagent container number (vial number), serial number independently allocated to each reagent, usable life indicating until when the reagent is usable, available number of times which indicates how many measurements can be conducted by using the reagent, and the like. It should be noted that reagents used in analysis performed by the blood coagulation analyzer according to the present embodiment include a reagent that is in frozen-storage and is thawed to be used, and a reagent that is freeze-dried powder and is dissolved in purified water to be used. The bar code of a reagent container that contains such a reagent also includes a record of the user ID of an operator (reagent preparer) who prepared the reagent. A bar code reader 11a for reading a reagent bar code is provided near the first reagent table 11 and the second reagent table 12, and when reagents are set, that is, immediately after the sample analyzer 1 is activated or when a reagent is replaced, reagent information is read by the bar code reader, from each reagent container accommodated in the first reagent table 11 and the second reagent table 12. The information read in this manner is stored in a hard disk 404 provided in the information processing unit 3 described below, in conjunction with information of holding positions in the first reagent table 11 and the second reagent table 12. Accordingly, when a measurement of a sample is performed, it is possible to identify in which holding position a reagent used in the sample measurement is located.

As shown in FIG. 2, each of the cuvette table 15 and the heating table 16 is provided with a plurality of cuvette holding holes 15a (16a), along the periphery thereof. After cuvettes are set in cuvette holding holes 15a (16a), the cuvettes are to be moved, in accordance with the rotation of the cuvette table 15 (the heating table 16), along the periphery thereof. The heating table 16 heats cuvettes set in the holding holes 16a, at a predetermined temperature.

Each of the sample dispensing units 21 and 22 has an arm extending in the horizontal direction, and can move a pipette provided at the tip of the arm, by rotating the arm. Aspiration and discharge of a sample is performed by use of the pipette. Each of the reagent dispensing units 23 to 25 has a similar configuration to that of the sample dispensing units, and can aspirate a reagent from a reagent container set in the first reagent table 11 or the second reagent table 12 and discharge the reagent into a cuvette, by use of the pipette provided at the tip of its swingable arm.

Moreover, the measurement unit 2 is provided with a plurality of catcher units 26 to 28. Cuvettes can be moved by these catcher units 26 to 28.

The cuvette supply port 34 is always supplied with a new cuvette. A new cuvette is set in a cuvette holding hole 15a in the cuvette table 15, by catcher units 26 or 27. Disposal holes 35 and 36 are holes into which cuvettes are discarded for which analyses have been performed and which are no more necessary.

Twenty holding holes 41 for holding cuvettes are formed in a top surface of the detection unit 40. A detector (not shown) is provided on the rear surface of the bottom of the detection unit 40. When a cuvette is set in a holding hole 41, optical information of the measurement specimen in the cuvette is detected by the detector.

The transporting unit 50 includes a transporting path 51. A pre-analysis rack holding area is provided on a right portion, a transportation area is provided in the middle, and a post-analysis rack holding area is provided on a left portion, on the bottom surface of the transporting path 51. The transporting path 51 is formed in a U-shape. A sample bar code reader 52 reads the bar code of a barcode label attached to each sample container 61 accommodated in a sample rack 60 being transported in the transportation area.

Moreover, the measurement unit 2 is provided with a controller 300 for controlling each mechanism included in the measurement unit 2. The controller 300 includes a CPU 301 for executing a control program stored in a memory not shown. The controller 300 is communicably connected to the information processing unit 3.

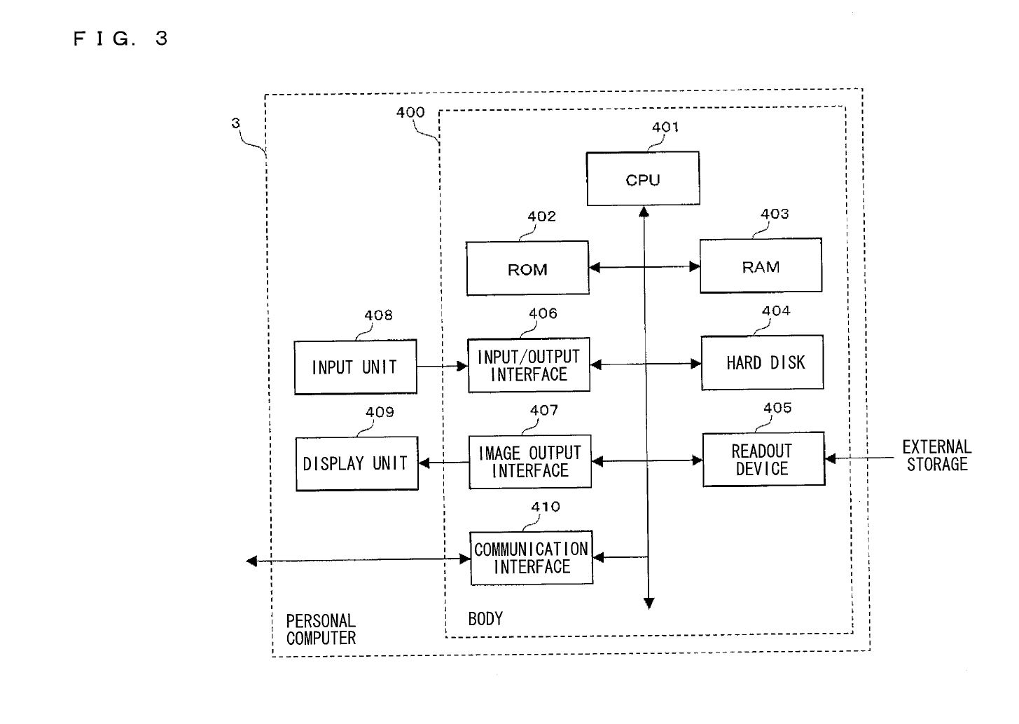

FIG. 3 is a block diagram showing a configuration of the information processing unit 3.

The information processing unit 3 is implemented by a personal computer, and includes a body 400, an input unit 408, and a display unit 409. The body 400 includes a CPU 401, a ROM 402, a RAM 403, the hard disk 404, a readout device 405, an input/output interface 406, an image output interface 407, and a communication interface 410.

The CPU 401 executes computer programs stored in the ROM 402 and computer programs loaded onto the RAM 403. The RAM 403 is used for reading computer programs stored in the ROM 402 and the hard disk 404. Further, when these computer programs are executed, the RAM 403 is used as a work area for the CPU 401.

Various computer programs to be executed by the CPU 401 and data used in the execution of the computer programs, such as an operating system and application programs, are installed in the hard disk 404. That is, computer programs for causing the computer to function as an information processing apparatus according to the present embodiment are installed in the hard disk 404.

Moreover, the hard disk 404 is provided with a reagent information data base DB1 for storing information of reagents set in the measurement unit 2, an analysis result data base DB2 for storing analysis results, a quality control data base DB3 for storing analysis results of quality control specimens, and a calibration curve data base DB4 for storing information of calibration curves.

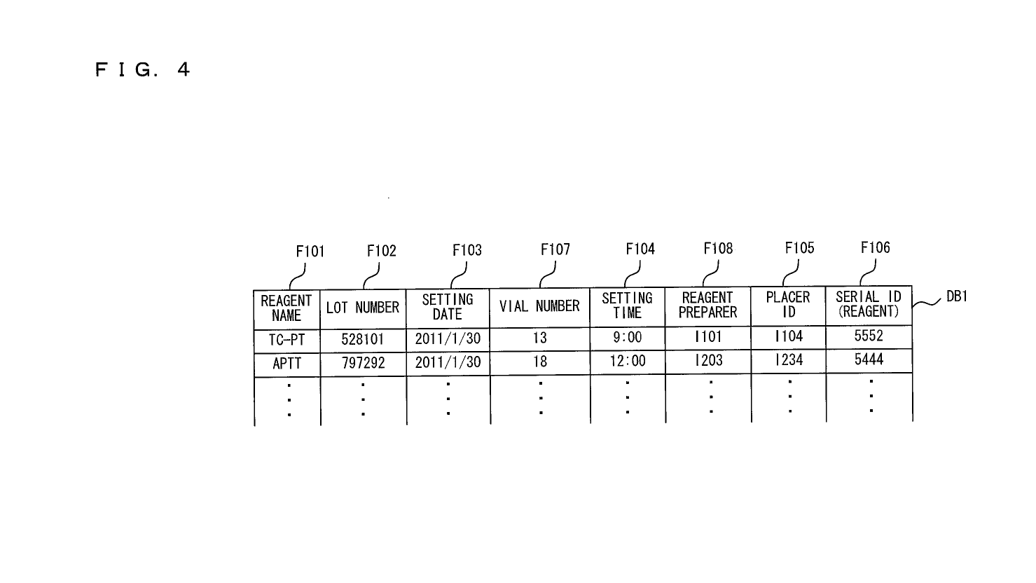

Information of reagents that were set in the past in the measurement unit 2 is stored in the reagent information data base DB1. FIG. 4 is a schematic diagram showing a configuration of the reagent information data base DB1. As shown in FIG. 4, the reagent information data base DB1 is provided with a field F101 for storing the name of a reagent, a field F102 for storing the lot number of the reagent, a field F107 for storing the vial number of the reagent container (vial) in which the reagent was contained, fields F103 and F104 for storing the date and the time, respectively, at which the reagent was set on the measurement unit 2, a field F108 for storing the user ID of an operator who prepared the reagent (reagent preparer), a field F105 for storing the user ID of an operator (placer) who placed the reagent in the measurement unit 2, and a field F106 for storing the serial number of the reagent. As described above, reagents to be used in the blood coagulation analyzer according to the present embodiment include a reagent that is in frozen-storage and is thawed to be used, and a reagent that is freeze-dried powder and is dissolved in purified water to be used. Therefore, even if a reagent of the same lot number is used, concentrations of reagents may vary for respective reagent containers (vials), depending on the reagent preparer. Such variation could influence measurement results. Since the vial numbers and the user IDs of reagent preparers are stored in the reagent information data base DB1, by displaying the vial number and the user ID of the relevant reagent preparer, it is possible to easily identify a reagent of which vial was used in the measurement, and who is the operator that prepared the reagent. Accordingly, it is possible to easily verify the state of the reagent used in the measurement, and thus, it is possible to easily clarify the cause of the variation of the measurement results. It should be noted that reagents are usually stored in a refrigerator at night, and are set in the measurement unit 2 of the sample analyzer 1 every morning when operation of the facility is started. When a reagent is consumed and its reagent container is emptied, the reagent container is replaced with a new reagent container containing a new reagent. At the time of activation of the sample analyzer 1 and at the time of replacement of reagents, reagent information of set reagents is stored in the reagent information data base DB1.

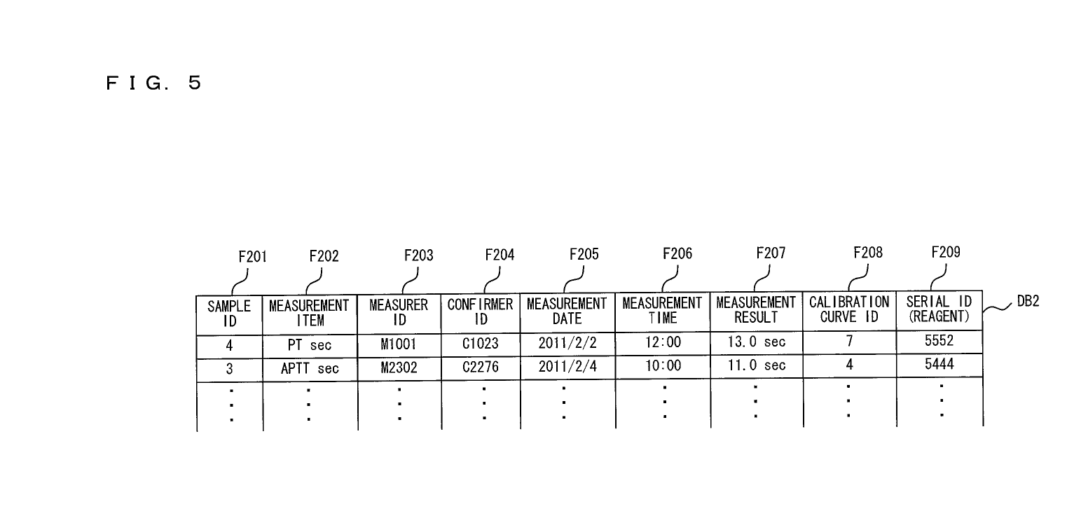

Analysis results of samples for which analyses were performed in the past by the sample analyzer 1 are stored in the analysis result data base DB2. FIG. 5 is a schematic diagram showing a configuration of the analysis result data base DB2. As shown in FIG. 5, the analysis result data base DB2 is provided with a field F201 for storing the sample ID for identifying a measured sample, a field F202 for storing a measurement item, a field F203 for storing the user ID of an operator who performed the measurement of the sample, a field F204 for storing the user ID of an operator who approved the analysis result of the sample, fields F205 and F206 for storing the date and the time, respectively, at which the measurement of the sample were performed, a field F207 for storing an analysis result (measurement value) of the sample, a field F208 for storing the calibration curve ID indicating a calibration curve used in the analysis of the measurement data, and a field F209 for storing the serial number of a reagent used in the measurement of the sample. Here, the date and the time (measurement date and measurement time) that are respectively stored in the fields F205 and F206 of the analysis result data base DB2 are the date and the time at which the sample ID was read, by the sample bar code reader 52, from the barcode label attached to the sample container for the corresponding measurement of the sample. It should be noted that, the measurement date and the measurement time are not limited thereto, and for example, may be the date and the time at which a sample analysis ends and a sample analysis result is stored in the analysis result data base DB2.

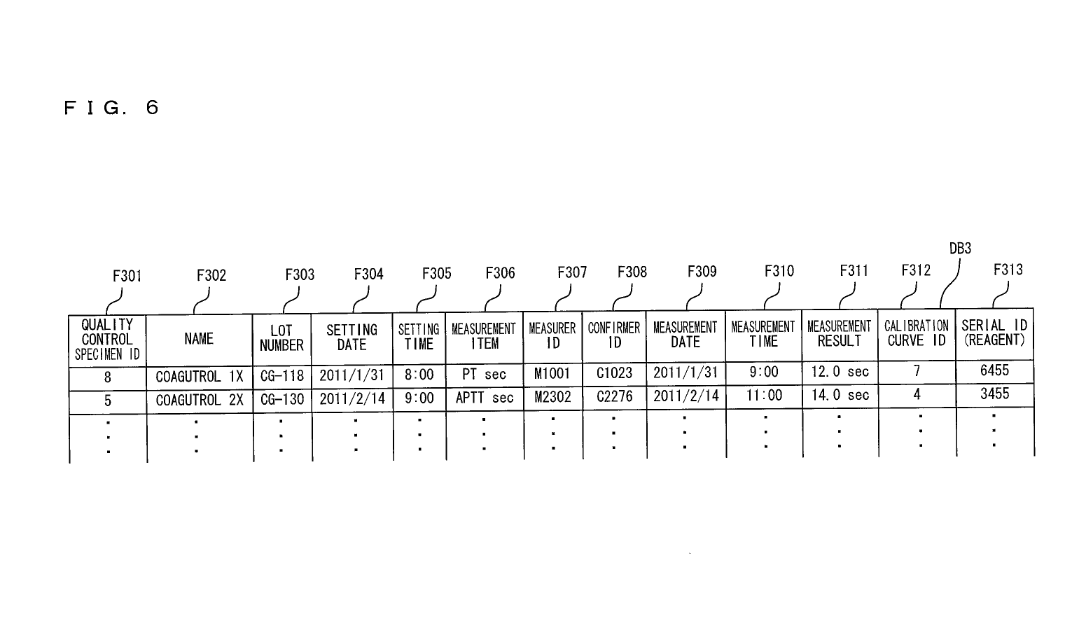

Results (measurement results) of measurements of quality control specimens performed in the past by the sample analyzer 1 are stored in the quality control data base DB3. FIG. 6 is a schematic diagram showing a configuration of the quality control data base DB3. As shown in FIG. 6, the quality control data base DB3 is provided with a field F301 for storing the quality control specimen ID for identifying a quality control specimen that was measured, a field F302 for storing the name of the quality control specimen, a field F303 for storing the lot number of the quality control specimen, fields F304 and F305 for storing the date and the time, respectively, at which the quality control specimen was set in the analyzer, a field F306 for storing a measurement item, a field F307 for storing the user ID of an operator who performed the measurement of the quality control specimen, a field F308 for storing the user ID of an operator who approved the quality control result, fields F309 and F310 for storing the date and the time, respectively, at which the measurement of the quality control specimen was performed, a field F311 for storing an analysis result (measurement value) of the quality control specimen, a field F312 for storing the calibration curve ID indicating a calibration curve used in the analysis of the measurement data, and a field F313 for storing the serial number of a reagent used in the measurement of the quality control specimen. Here, the date and the time at which the quality control specimen was started to be used will be described. One quality control specimen is used in a plurality of measurements. That is, after the container of a quality control specimen is opened and the quality control specimen is started to be used, the quality control specimen is subjected to a plurality of measurements. A barcode label on which a bar code storing the quality control specimen ID is printed is attached to the container of the quality control specimen, and when the quality control specimen is measured, the bar code is read by the sample bar code reader 52 described above. The fields F304 and F305 described above store the date and the time, respectively, at which the quality control specimen ID of one quality control specimen was read for the first time by the sample bar code reader 52, as the date and the time at which the quality control specimen was set.

The date and the time (measurement date and measurement time) respectively stored in the fields F309 and F310 of the quality control data base DB3 are the date and the time, in each measurement of a quality control specimen, at which the quality control specimen ID was read by the sample bar code reader 52, from the barcode label attached to the container of the quality control specimen. It should be noted that, the measurement date and the measurement time are not limited thereto, and for example, may be the date and the time at which a measurement of a quality control specimen ends and an analysis result of the quality control specimen is stored in the quality control data base DB3.

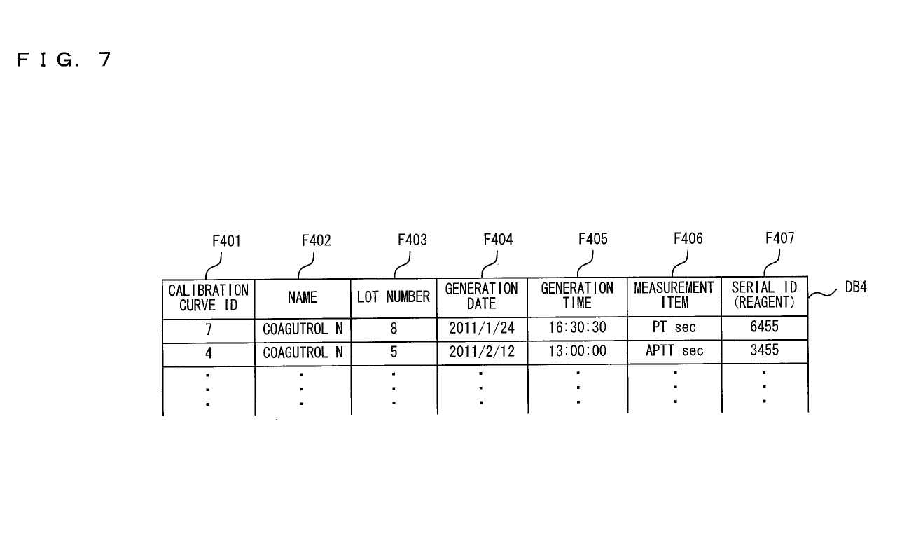

When a sample or a quality control specimen is measured by the measurement unit 2, resultant measurement data is provided to the information processing unit 3. The information processing unit 3 generates an analysis result (measurement value) from the measurement data, using a calibration curve. A calibration curve is generated by the measurement unit 2 measuring a calibrator, which is a specimen dedicated for calibration curve generation. Information about the calibration curve thus generated is stored in the calibration curve data base DB4. FIG. 7 is a schematic diagram showing a configuration of the calibration curve data base DB4. As shown in FIG. 7, the calibration curve data base DB4 is provided with a field F401 for storing the calibration curve ID for identifying a calibration curve, a field F402 for storing the name of the calibrator used in generating the calibration curve, a field F403 for storing the lot number of the calibrator used in generating the calibration curve, fields F404 and F405 for storing the generation date and the generation time of the calibration curve, respectively, a field F406 for storing a measurement item, and a field F407 for storing the serial number of a reagent used in the measurement of the calibrator.

The readout device 405 is implemented by a CD drive, a DVD drive, or the like, and can read computer programs and data stored in a storage medium. The input unit 408 implemented by a mouse and a keyboard is connected to the input/output interface 406, and by a user using the input unit 408, data is inputted to the information processing unit 3. The image output interface 407 is connected to the display unit 409 which is implemented by a CRT, a liquid crystal panel, or the like, and outputs video signals in accordance with image data, to the display unit 409. The display unit 409 displays an image, based on the inputted video signals. The communication interface 410 allows the information processing unit 3 to transmit/receive data to/from the measurement unit 2.

### [Operations of the Sample Analyzer]

Hereinafter, operations of the sample analyzer 1 according to the present embodiment will be described.

### <Reagent Information Registration Operation>

First, description will be given of operations performed by the sample analyzer 1 when information of a reagent set in the measurement unit 2 is registered into the reagent information data base DB1. Registration of reagent information is performed at the time of activation of the sample analyzer 1 and at the time of reagent replacement. Here, registration of reagent information performed at the time of activation of the sample analyzer 1 will be described.

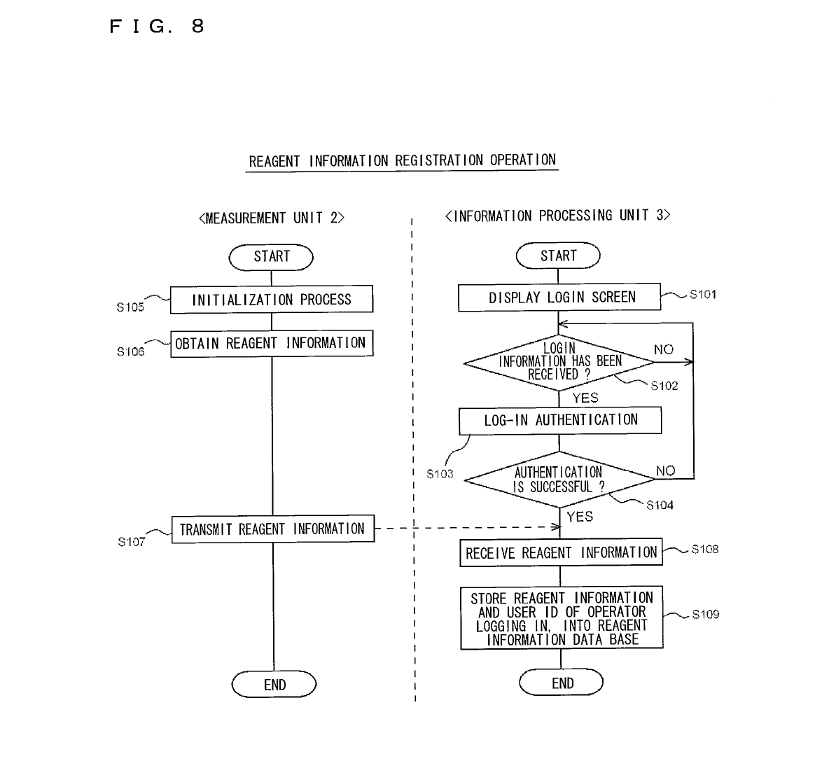

FIG. 8 is a flow chart showing steps of a reagent information registration operation. Upon activation of the sample analyzer 1, the CPU 401 of the information processing unit 3 causes the display unit 409 to display a login screen (step S101). The login screen is provided with an input box into which the user ID and the password (login information) of an operator are inputted. The operator operates the input unit 408 and inputs the login information to the information processing unit 3. The CPU 401 determines whether an input of login information has been received (step S102). When login information has not been received (NO in step S102), the CPU 401 performs the process of step S102 again. When an input of login information has been received in step S102 (YES in step S102), the CPU 401 checks the received login information against registered user information stored in the hard disk, and performs log-in authentication (step S103). Next, the CPU 401 determines whether the log-in authentication is successful (step S104). When the authentication has failed (NO in step S104), the CPU 401 returns the processing to step S102. On the other hand, when the log-in authentication is successful, (YES in step S104), the CPU 401 advances the processing to step S108.

Meanwhile, in the measurement unit 2, upon activation of the sample analyzer 1, an initialization process is performed by the CPU 301 of the controller 300 (step S105). Then, while the first reagent table 11 and the second reagent table 12 are being rotationally driven, the CPU 301 drives the reagent bar code reader 11a to read the bar code of each reagent container held in the first reagent table 11 and the second reagent table 12, thereby obtaining reagent information (step S106). Then, the CPU 301 transmits the obtained reagent information to the information processing unit 3 (step S107). Here, the reagent information includes, as the setting date and the setting time (information registered in the fields F103 and F104), the date and the time at which the reagent information was read from the bar code of the corresponding reagent container held in the first reagent table 11 or the second reagent table 12. After step S107, the CPU 301 ends the processing.

In step S108, the CPU 401 receives the reagent information transmitted from the measurement unit 2 (step S108). Further, the CPU 401 stores, in the reagent information data base DB1, the received reagent information and the user ID of the operator logging in at that time (step S109), and ends the processing.

Although detailed description is omitted, reagent information of a reagent that is newly set in reagent replacement is also registered in the reagent information data base DB1. The setting date and the setting time of a reagent to be registered in the reagent information data base at the time of reagent replacement are the date and the time at which the reagent information is read from the bar code of the newly set reagent container.

### <Measuring Operation>

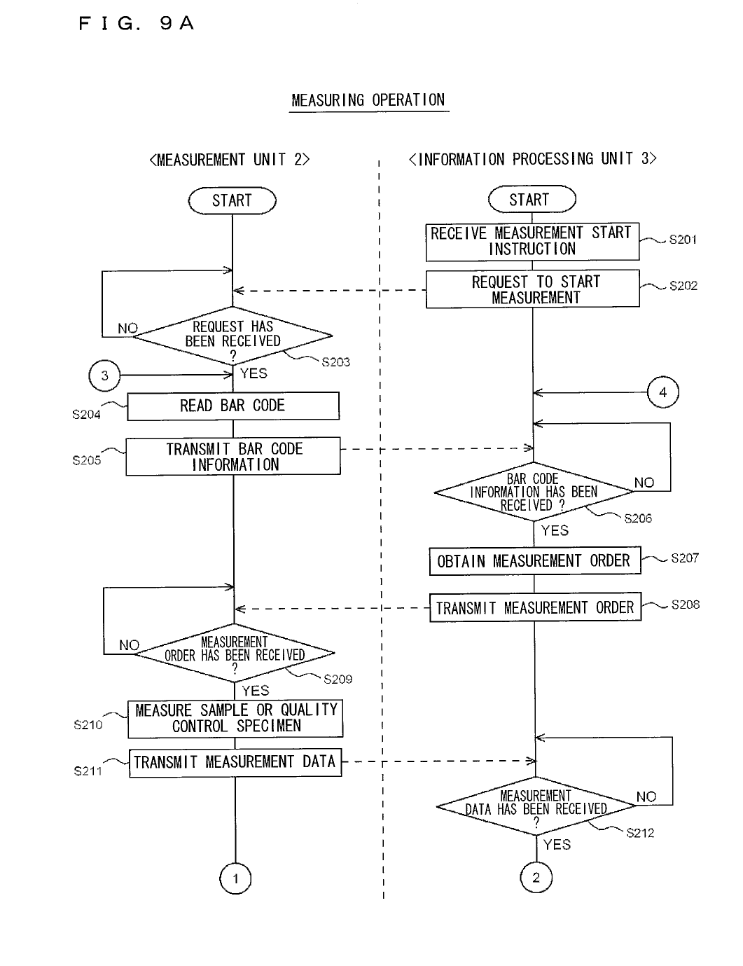

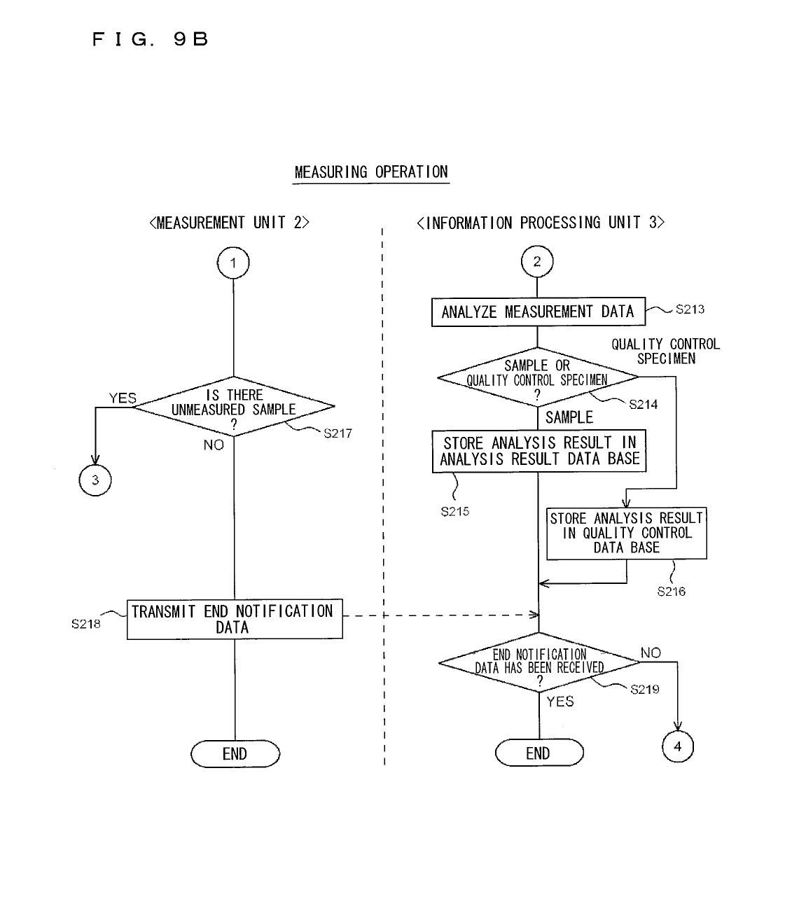

Next, description will be given of operations performed by the sample analyzer 1 when it measures a sample of a subject or a quality control specimen. FIG. 9A and FIG. 9B show flow charts showing steps of the measuring operation. When measuring a sample or a quality control specimen, an operator places, in a sample rack, a sample container containing a sample or a container containing a quality control specimen, and places the sample rack in the pre-analysis rack holding area of the transporting unit 50. By operating the input unit 408 of the information processing unit 3 in this state, the operator issues an instruction to start measurement to the sample analyzer 1.

Upon receiving the instruction to start measurement (step S201), the CPU 401 of the information processing unit 3 transmits request data that requests to start measurement, to the measurement unit 2 (step S202). The CPU 301 of the measurement unit 2 determines whether the request data has been received (step S203), and when the request data has not been received (NO in step S203), performs the process of step S203 again. When the measurement unit 2 has received the request data (YES in step S203), the CPU 301 controls the transporting unit 50 and causes the transporting unit 50 to transport the sample rack 60. After being moved rearward in the pre-analysis rack holding area, the sample rack 60 is moved leftward in the transportation area. At this time, the CPU 301 controls the sample bar code reader 52 and causes the sample bar code reader 52 to read the barcode label attached to the sample container 61 containing a sample or a quality control specimen (step S204). Next, the CPU 301 transmits, to the information processing unit 3, the information read by the sample bar code reader 52 (hereinafter referred to as “bar code information”) (step S205). Bar code information read from a sample container containing a sample includes a sample ID, and bar code information read from a sample container containing a quality control specimen includes a quality control specimen ID and a measurement item(s).

The CPU 401 of the information processing unit 3 determines whether the bar code information has been received (step S206), and when the bar code information has not been received, (NO in step S206), performs the process of step S206 again. When the information processing unit 3 has received the bar code information (YES in step S206), the CPU 401 obtains a measurement order based on the bar code information (step S207). When a sample is to be measured, the measurement item(s) is specified by a measurement order. The sample analyzer 1 allows a user to register a measurement order and also is able to receive a measurement order from a server apparatus not shown. That is, in a case where a user is to register a measurement order, the user operates the input unit 408 of the information processing unit 3, thereby inputting the measurement order to the sample analyzer 1. In a case where a measurement order is received from a server apparatus, a user registers the measurement order to the server apparatus in advance. In the present embodiment, a measurement order means specifying one or more measurement items for each sample and ordering the sample analyzer 1 to perform a measurement for the specified measurement item(s). Therefore, one measurement order is inputted for one sample, and one measurement order includes one or more measurement items. When a sample is to be measured, the information processing unit 3 obtains a measurement order for the sample, by using, as a key, the sample ID contained in the bar code information. That is, when a measurement order is registered by a user to the sample analyzer 1, the measurement order corresponding to the sample ID is read from the hard disk 404 of the information processing unit 3; and when a measurement order is obtained from a server apparatus, the sample ID is transmitted from the information processing unit 3 to the server apparatus, the server apparatus transmits the measurement order corresponding to the received sample ID to the information processing unit 3, and the information processing unit 3 receives the measurement order. On the other hand, in a case where a quality control specimen is to be measured, its bar code information contains a measurement item(s), and the CPU 401 generates a measurement order from the measurement item(s) contained in the bar code information.

Next, the CPU 401 transmits the measurement order obtained as described above, to the measurement unit 2 (step S208). The CPU 301 of the measurement unit 2 determines whether the measurement order has been received (step S209), and when the measurement order has not been received (NO in step S209), performs the process of step S209 again. When the measurement unit 2 has received the measurement order (YES in step S209), the CPU 301 performs a measurement of the sample or quality control specimen (step S210).

The measurement process of step S210 will be described. It should be noted that although a measurement of a sample will be described here, a measurement of a quality control specimen is performed in a similar manner. The sample rack 60 transported by the transporting unit 50 is located at a predetermined aspirating position in the transportation area. At this aspirating position, the sample is aspirated by the sample dispensing unit 21 or 22. When the aspiration of the sample ends, the sample rack 60 is moved leftward in the transportation area, and then moved forward in the post-analysis rack holding area.

The catcher unit 27 sets a cuvette supplied to the cuvette supply port 34, in a cuvette holding hole 15a of the cuvette table 15. The sample dispensing unit 21 aspirates the sample in the sample container 61 located the predetermined sample aspirating position 53 in the transportation area of the transporting path 51. The sample aspirated by the sample dispensing unit 21 is discharged into a cuvette set in the cuvette holding hole 15a located at a sample discharging position 18 at a front portion of the cuvette table 15.

Next, from the cuvette into which the sample has been discharged by the sample dispensing unit 21, amounts of sample corresponding to several measurement items, respectively, are subdivided into other cuvettes set in the cuvette table 15. Each cuvette corresponds to one measurement item, and the sample subdivided into a cuvette is measured for the measurement item for the cuvette.

The sample dispensing unit 22 dispenses the sample in the cuvette held in the cuvette table 15, into another cuvette. The cuvette into which the sample has been dispensed is gripped by the catcher unit 26, and set in a cuvette holding hole 16a of the heating table 16. Moreover, with respect to the cuvette held in the cuvette holding hole 15a of the cuvette table 15, after the sample has been aspirated therefrom and the cuvette is no more needed, the cuvette is discarded into the disposal hole 36 by the catcher unit 27.

The sample contained in the cuvette set in the heating table 16 is heated for a time period corresponding to its measurement item. For example, when the measurement item is PT, the sample is heated for three minutes, and when the measurement item is APTT, the sample is heated for one minute.

After the sample is heated, a trigger reagent is mixed into the sample. For example, when the measurement item is PT, a PT reagent (trigger reagent) is dispensed into the cuvette containing the heated sample, and the mixture is subjected to optical measurement by the detection unit 40.

In this case, the cuvette held in the cuvette holding hole 16a in the heating table 16 is once moved from the cuvette holding hole 16a to a predetermined position by the catcher unit 28, where the reagent dispensing unit 24 or 25 dispenses, into this cuvette, a trigger reagent in a predetermined reagent container 200 placed on the first reagent table 11 or the second reagent table 12. It should be noted that, for some measurement items, after the sample is heated for a predetermined time period, an intermediate reagent is dispensed into the cuvette, and after the cuvette is heated for a predetermined time period again, a trigger reagent is dispensed.

After the trigger reagent is discharged as described above, the catcher unit 28 sets the cuvette into which the reagent is discharged, in the holding hole 41 of the detection unit 40. Then, optical information of the measurement specimen contained in the cuvette is detected by the detection unit 40.

The cuvette for which optical measurement by the detection unit 40 has ended and which is no more needed is moved, being gripped by the catcher unit 28, to a position over the disposal hole 35, and is discarded into the disposal hole 35. Now, the measurement of one sample performed by the measurement unit 2 is completed.

The CPU 301 of the measurement unit 2 transmits, to the information processing unit 3, measurement data containing optical information detected by the detection unit 40 (step S211). The CPU 401 of the information processing unit 3 determines whether the measurement data has been received (step S212), and when the measurement data has not been received (NO in step S212), performs the process of step S212 again. When the information processing unit 3 has received the measurement data (YES in step S212), the CPU 401 performs an analysis of the measurement data, and generates an analysis result of the sample or the quality control specimen (step S213). In the analysis process of the measurement data, a calibration curve corresponding to the measurement item is used. That is, the CPU 401 generates an analysis result (measurement value) from the measurement data, using the calibration curve.

Next, the CPU 401 determines whether the analysis result obtained in step S213 is of a sample or a quality control specimen (step S214). When the analysis result is of a sample (“sample” in step S214), the CPU 401 stores the obtained analysis result, in the analysis result data base DB2 (step S215). On the other hand, when the analysis result is of a quality control specimen (“quality control specimen” in step S214), the CPU 401 stores the obtained analysis result, in the quality control data base DB3 (step S216). In step S215 or step S216, as the user ID of the operator who issued an instruction to analyze the sample or the quality control specimen, the user ID of the operator logging in at the time is stored in the analysis result data base DB2 or the quality control data base DB3.

After the measurement process of the sample or the quality control specimen ends, the CPU 301 of the measurement unit 2 determines whether there is an unmeasured sample or quality control specimen (step S217). Whether there is an unmeasured sample or quality control specimen is determined by a sensor provided in the transporting unit 50 detecting whether the sample rack being transported is holding a sample container containing an unmeasured sample or quality control specimen. When it is determined that there is an unmeasured sample or quality control specimen in step S217 (YES in step S217), the CPU 301 returns the processing to step S204. On the other hand, when it is determined that there is no unmeasured sample or quality control specimen in step S217 (NO in step S217), the CPU 301 transmits, to the information processing unit 3, end notification data for notifying the information processing unit 3 of ending the measurement (step S218), and ends the processing.

On the other hand, the CPU 401 of the information processing unit 3 determines whether the end notification data has been received (step S219). When the information processing unit 3 has not received the end notification data (NO in step S219), the CPU 401 returns the processing to step S206. When the information processing unit 3 has received the end notification data (YES in step S219), the CPU 401 ends the processing.

### <Quality Control Result Displaying Operation>

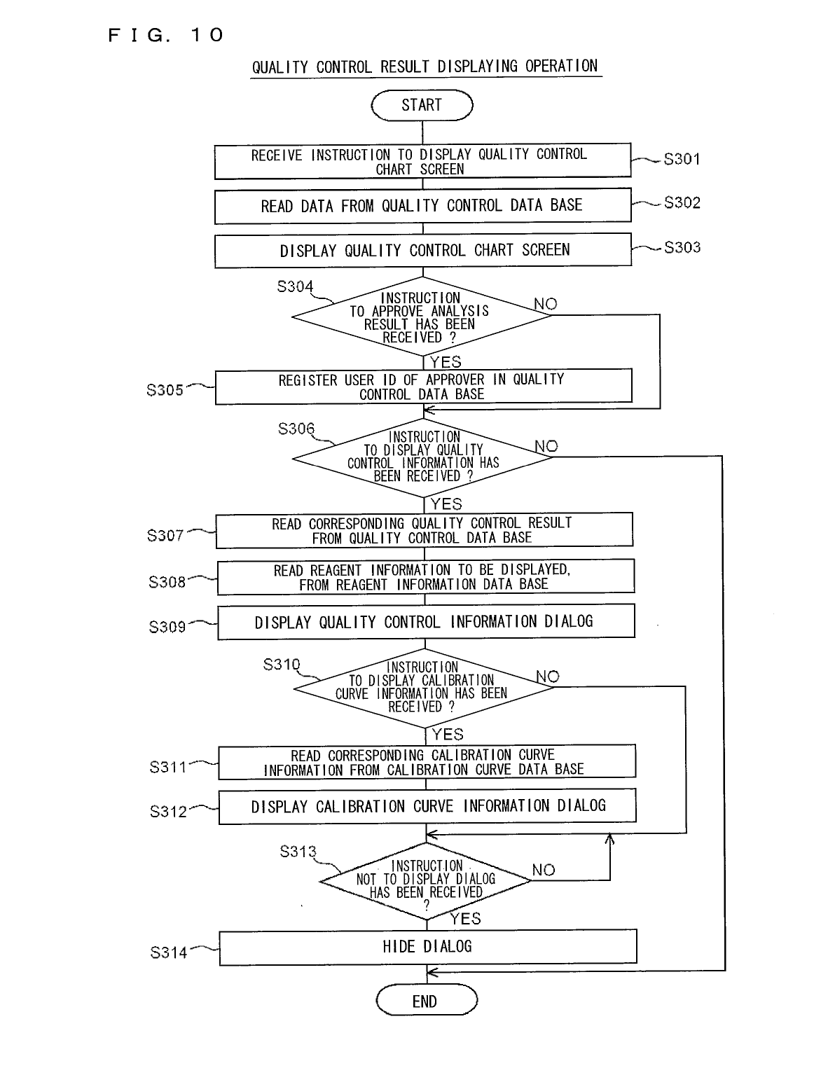

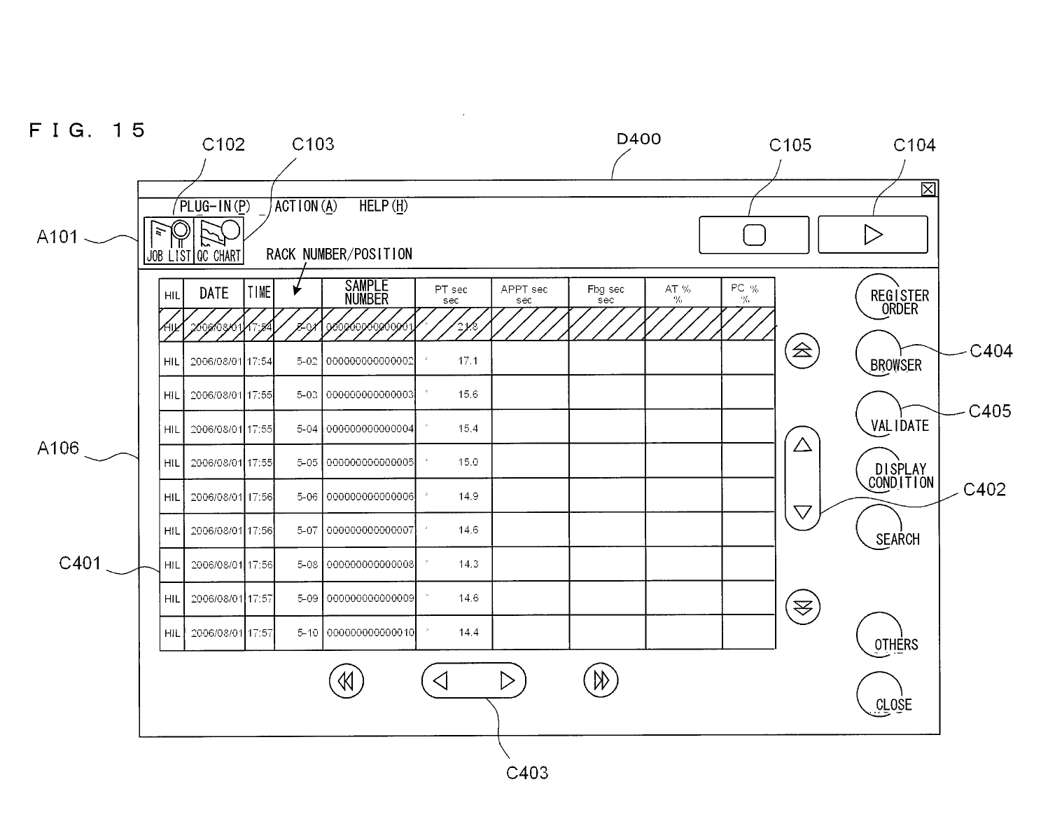

Next, description will be given of a quality control result displaying operation for displaying an analysis result of a quality control specimen obtained through the above-described measuring operation. FIG. 10 is a flow chart showing steps of the quality control result displaying operation. An operator can issue an instruction to display a quality control chart screen, by operating the input unit 408 of the information processing unit 3. For example, by an operator selecting, through a mouse click operation or the like, an icon C103 provided in a tool bar A101 of a job list screen described below (see FIG. 15), an instruction to display a quality control chart screen is given to the information processing unit 3. Upon receiving the instruction to display a quality control chart screen (step S301), the CPU 401 of the information processing unit 3 reads data of an analysis result of a corresponding quality control specimen registered in a quality control data base DB3 (step S302), and causes the display unit 409 to display the quality control chart screen (step S303).

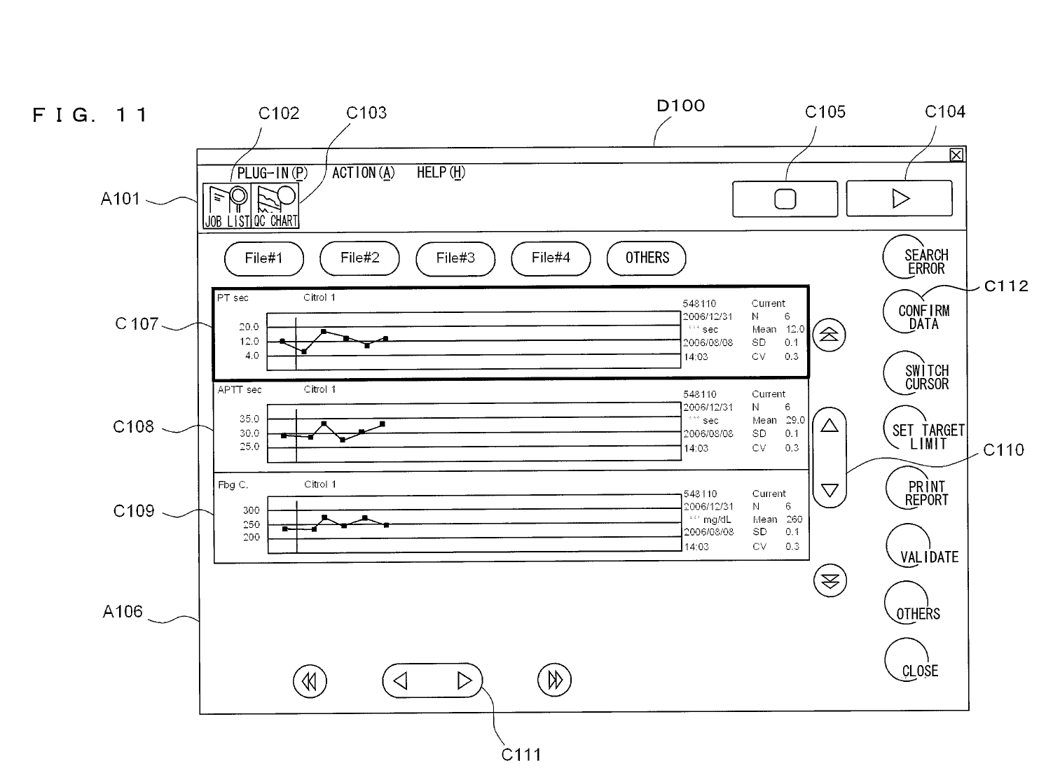

FIG. 11 shows an example of the quality control chart screen. As shown in FIG. 11, a quality control chart screen D100 is provided, in an upper area of the screen, with the tool bar A101 in which a plurality of icons are arranged. The tool bar A101 is commonly provided in other screens to be displayed on the information processing unit 3. That is, when the display is switched from one screen of the information processing unit 3 to another screen, the tool bar A101 is provided in both of the screens before and after the switch of the screens. The tool bar A101 is provided with an icon C102 for switching the display to a job list screen described below, the icon C103 for switching the display from another screen to the quality control chart screen D100, an icon C104 for instructing the measurement unit 2 to start measurement of a sample or quality control specimen, and an icon C105 for instructing the measurement unit 2 to suspend the measuring operation.

Below the tool bar A101, a work area A106 that accounts for a large portion of the quality control chart screen D100 is provided. In the work area A106, charts (hereinafter referred to as “quality control charts”) C107 to C109 representing analysis results for respective measurement items of a quality control specimen are displayed. The quality control charts C107 to C109 indicate analysis results of one quality control specimen. More specifically, each of the quality control charts C107 to C109 indicates a time series graph of corresponding analysis results, which were obtained by one quality control specimen being subjected to a plurality of measurements. The quality control chart C107 is a line graph, and each point represents a value of an analysis result. Each of the quality control chart C107 to C109 is generated for its corresponding measurement item. In the example of FIG. 11, the quality control chart C107 corresponds to a measurement item “PT”, the quality control chart C108 corresponds to a measurement item “APTT”, and the quality control chart C109 corresponds to a measurement item “Fbg”. Each of the quality control charts C107 to C109 can be selected through a mouse click operation or the like. When one quality control chart is selected, a black frame is displayed around the selected quality control chart, thereby indicating that the quality control chart is selected. In the example of FIG. 11, the quality control chart C107 is selected. Further, when a mouse double click operation is performed onto one of the quality control charts C107 to C109 being displayed on the quality control chart screen D100, an instruction to display quality control information for the measurement item of that quality control chart is given to the information processing unit 3. The quality control information will be described below.

Each point, being a result of analysis of the quality control specimen, that is displayed on the graph of each of the quality control charts C107 to C109 can be selected through a mouse click operation or the like. Further, scroll buttons C110 and C111 for scrolling the display are provided to the right of and below the quality control charts C107 to C109.

A plurality of icons are arranged to the right of the scroll button C110. These icons include an icon C112 for confirming data. The icon C112 can be selected through a mouse click operation or the like. When the icon C112 is selected while one of the points representing analysis results of the quality control charts C107 to C109 is selected, approval (validation) of that analysis result is performed. An operator having authority to approve an analysis result of a quality control specimen performs approval when he or she determines that the analysis result is appropriate. When approval of an analysis result is performed, the user ID of the operator who performed the approval, that is, of the operator logging in at the time of the approval, is stored in the field F308 of the record of the approved analysis result in the quality control data base DB3.

With reference back to FIG. 10, description of the quality control result displaying operation will be continued. The CPU 401 determines whether an instruction to approve the analysis result of the quality control specimen as described above has been received (step S304). When the instruction to approve the analysis result has been received (YES in step S304), the CPU 401 registers the user ID of the operator who performed the approval, in the corresponding record in the quality control data base DB3 (step S305), and advances the processing to step S306. On the other hand, when the instruction to approve the analysis result has not been received in step S304 (NO in step S304), the CPU 401 advances the processing directly to step S306.

In step S306, the CPU 401 determines whether an instruction to display quality control information has been received (step S306). When the instruction to display quality control information has not been received (NO in step S306), the CPU 401 ends the processing. On the other hand, when a mouse double click operation is performed onto one of the quality control charts C107 to C109 being displayed on the quality control chart screen D100, and an instruction to display quality control information is generated (YES in step S306), the CPU 401 reads, from the quality control data base DB3, analysis result data of the quality control specimen for the selected quality control chart (step S307). In this process, among analysis results of the quality control specimen, for which quality control charts C107 to C109 are being displayed at the time when the instruction to display quality control information is given, an analysis result of the measurement item selected by the instruction to display quality control information, that is, of the measurement item corresponding to the quality control chart for which the double click operation was performed, is read from the quality control data base DB3. Further, in a case where a plurality of analysis results are included in the selected quality control chart, all of the analysis results are read from the quality control data base DB3.

Further, the CPU 401 reads, from the reagent information data base DB1, reagent information of the reagent used in the measurement for obtaining the analysis result read in step S307 (step S308). At this time, in a case where a plurality of analysis results were read in step S307, reagent information of the reagent used in the measurement for obtaining the latest analysis result is read. More specifically, reagent information containing the same serial number as the reagent serial number contained in the record (analysis result data) read from the quality control data base DB3 is read from the reagent information data base DB1.

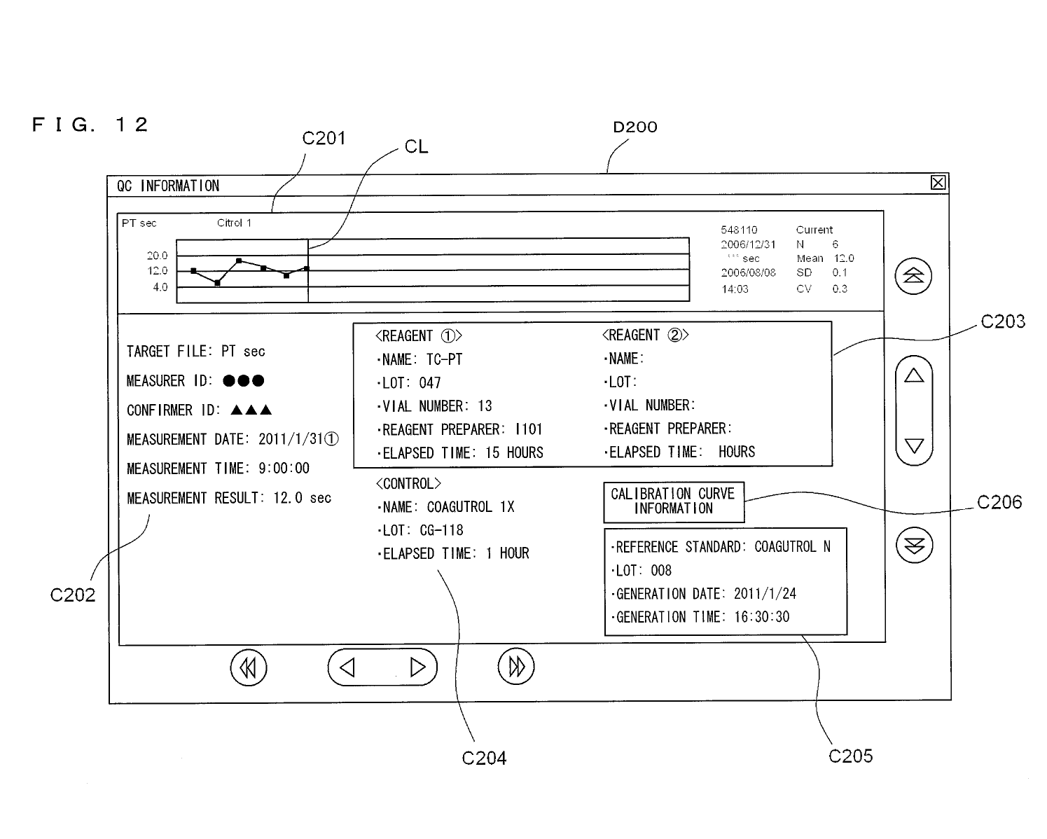

Next, based on the analysis result of the quality control specimen and the reagent information that have been read as above, the CPU 401 causes the display unit 409 to display a quality control information dialog (step S309). FIG. 12 shows an example of the quality control information dialog. As shown in FIG. 12, a quality control information dialog D200 includes a quality control chart C201, which is the same as the quality control chart whose quality control information is designated to be displayed, in the quality control chart screen D100. In the quality control chart C201, as in the quality control charts C107 to C109 in the quality control chart screen D100, each point representing an analysis result can be selected. In the initial state, the latest one of the analysis results displayed in the quality control chart C201 is selected. A cursor CL in the form of a vertical line is displayed over the selected analysis result point, thereby indicating that the point is selected.

Below the quality control chart C201 in the quality control information dialog D200, detailed information C202 of the selected analysis result, reagent information C203, quality control specimen information C204, and calibration curve information C205 are displayed. The detailed information C202 includes a measurement item (indicated as “TARGET FILE” in FIG. 12), the user ID (indicated as “MEASURER ID” in FIG. 12) of an operator who performed measurement of the quality control specimen, the user ID (indicated as “CONFIRMER ID” in FIG. 12) of an operator who performed approval of the analysis result, the measurement date, the measurement time, and a measurement result (measurement value).

The reagent information C203 is displayed to the right of the detailed information C202, and the quality control specimen information C204 and the calibration curve information C205 are displayed below the reagent information C203. In the reagent information C203, information of two reagents can be displayed. As types of measurement items, there are a measurement item for which only one reagent is used, and a measurement item for which two reagents are used. In a case where quality control information for a measurement item for which two reagents are used is displayed in the quality control information dialog D200, information of the two reagents used in the measurement is displayed in the reagent information C203. Meanwhile, as shown in FIG. 12, in a case where quality control information for a measurement item for which only one reagent is used is displayed in the quality control information dialog D200, information of that reagent used in the measurement is displayed in the reagent information C203. The reagent information C203 includes the reagent name, the lot number, the vial number, the reagent preparer, and the elapsed time. By the lot number being displayed, it is possible to confirm, for example, whether the reagent used in the measurement is a reagent of a lot number whose quality easily changes over time. Accordingly, when there is variation in results of a quality control measurement, the reagent may become one candidate for the cause of the variation. Further, by the vial number being displayed, an operator may additionally confirm, for example, a measurement result of another specimen measured by using the reagent having the same vial number, whereby the operator can verify whether there was an abnormality in the quality of the reagent of that vial number. Further, by the reagent preparer being displayed, it is possible to easily identify the operator who prepared the reagent, and thus, it is possible to ask the operator whether the reagent was appropriately prepared. As a result, it is possible to verify the state of the reagent used in the measurement, and thus, it is possible to easily confirm whether the variation in the results of the quality control measurement is due to an operation by the reagent preparer. The “elapsed time” means the time period from the time when the reagent was set in the measurement unit 2 for the first time until it was used in the measurement. The elapsed time is calculated based on the setting date and the setting time read from the reagent information data base DB1, and on the measurement date and the measurement time read from the analysis result data base DB2. By the elapsed time being displayed, the operator can easily understand the deterioration state of the reagent at the time when the quality control specimen was measured, and thus, can easily determine whether the variation in the results of the quality control measurement is due to the deterioration of the reagent.

In the quality control information dialog D200, the information of the quality control specimen read in step S307 is displayed as the quality control specimen information C204. The quality control specimen information C204 includes the name, the lot number, and the elapsed time of the quality control specimen. The “elapsed time” is a time period from the time when the quality control specimen was set in the analyzer for the first time until it was used in the measurement. By the elapsed time being displayed, the operator can easily understand the deterioration state of the quality control specimen at the time when the quality control specimen was measured. In the quality control information dialog D200, information of the calibration curve used in generation of the selected analysis result of the quality control specimen is displayed as the calibration curve information C205. The calibration curve information C205 includes the calibrator name (indicated as “REFERENCE STANDARD” in FIG. 12), the lot number, the generation date and the generation time of the calibration curve.

Further, a button C206 for displaying detailed information of the calibration curve is provided between the reagent information C203 and the calibration curve information C205. The button C206 can be selected by a mouse click operation or the like. When the button C206 is selected, an instruction to display detailed information of the calibration curve used in generation of the selected analysis result of the quality control specimen is given to the CPU 401.

With reference back to FIG. 10, description of the quality control result displaying operation will be continued. The CPU 401 determines whether the instruction to display detailed information of the calibration curve as described above has been received (step S310). When the instruction to display detailed information of the calibration curve has not been received (NO in step S310), the CPU 401 advances the processing to step S313. On the other hand, when the instruction to display detailed information of the calibration curve has been received (YES in step S310), the CPU 401 reads information of the calibration curve from the calibration curve data base DB4 (step S311) and causes the display unit 409 to display a calibration curve information dialog (step S312).

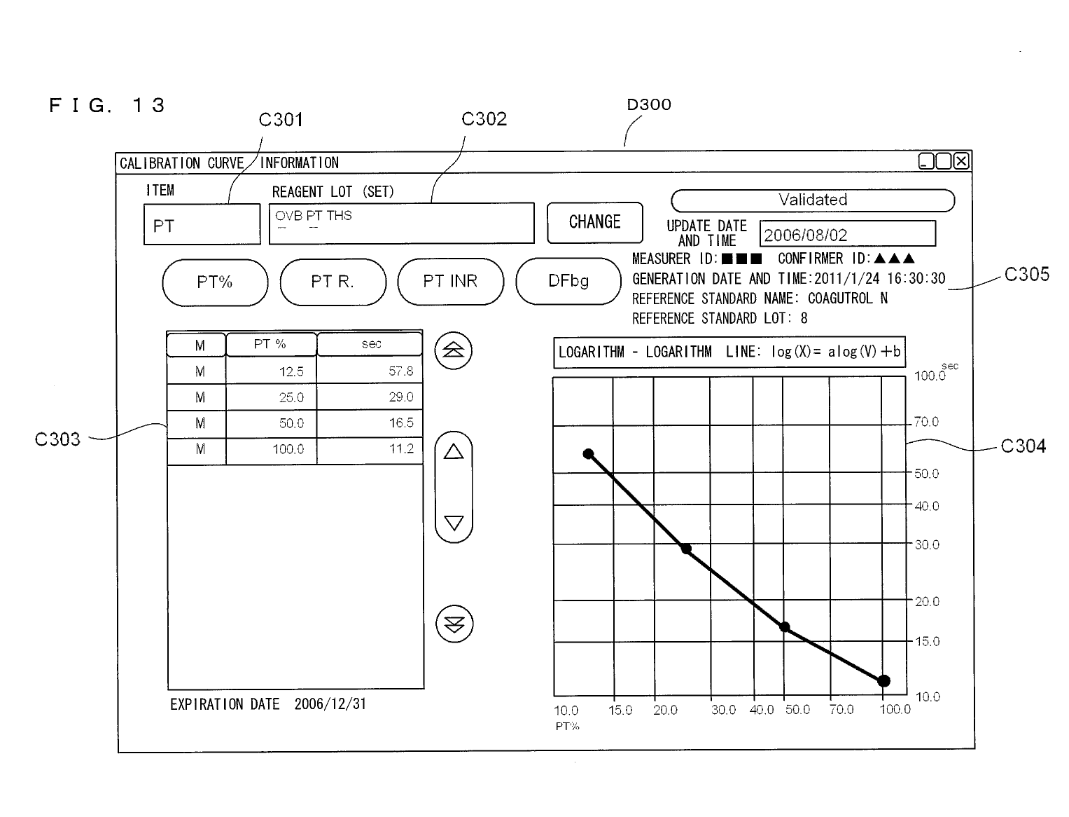

FIG. 13 shows an example of the calibration curve information dialog. A measurement item C301, lot information C302 of a reagent used in the measurement of the calibrator, a calibrator measurement result C303, a calibration curve graph C304, and calibration curve generation information C305 about generation of the displayed calibration curve are displayed in a calibration curve information dialog D300. The measurement item C301 is arranged in an upper left corner portion of the calibration curve information dialog D300, and the reagent lot information C302 is arranged to the right of the measurement item C301. The calibrator measurement result C303 is arranged below the measurement item C301 and the reagent lot information C302. In generation of a calibration curve, a plurality of calibrators having different concentrations are measured. A plurality of measurement results (numerical data) and the respective calibrator concentrations are listed in the calibrator measurement result C303. The calibration curve graph C304 is arranged to the right of the calibrator measurement result C303. The calibration curve graph C304 is a graph of the calibrator measurement result C303, and indicates a calibration curve representing the relationship between the measurement data of each calibrator and the concentration of the calibrator. The calibration curve generation information C305 is arranged above the calibration curve graph C304 and to the right of the reagent lot information C302. The calibration curve generation information C305 includes the user ID of the operator who performed the measurement of the calibrators (indicated as “MEASURER ID” in FIG. 13), the user ID of the operator who performed approval of the calibration curve (indicated as “CONFIRMER ID” in FIG. 13), the date and the time of generation of the calibration curve, the calibrator name, and the calibrator lot number. By being able to call the calibration curve information dialog D300 from the quality control information dialog D200, the operator can easily confirm the calibration curve used in the analysis of the quality control specimen, and can efficiently examine the validity of the quality control result.

With reference back to FIG. 10, description of the quality control result displaying operation will be continued. By clicking, with the mouse, the button indicating “x” provided at the upper right corner of each of the quality control information dialog D200 and the calibration curve information dialog D300, the operator can issue an instruction to close the corresponding dialog, to the information processing unit 3. The CPU 401 determines whether the instruction not to display a dialog has been received (step S313), and when the instruction not to display a dialog has not been received (NO in step S313), performs the process of step S313 again. On the other hand, when the instruction not to display a dialog has been received (YES in step S313), the CPU 401 closes a corresponding one of the quality control information dialog D200 and the calibration curve information dialog D300 (step S314), and ends the processing.

### <Sample Analysis Result Displaying Operation>

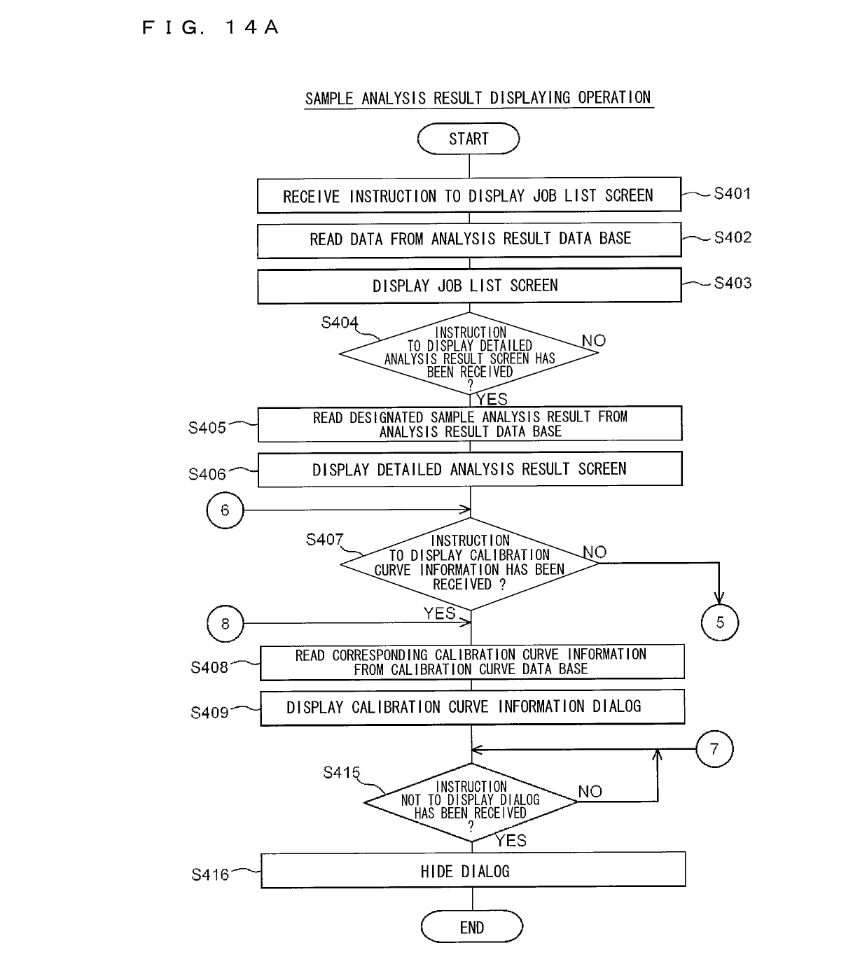

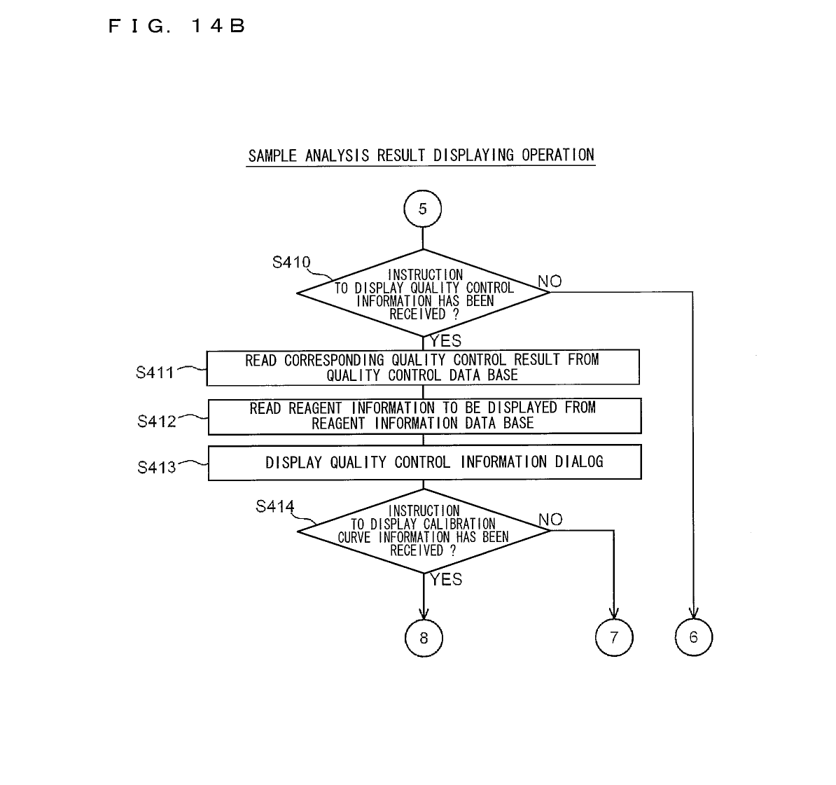

Next, description will be given of a sample analysis result displaying operation for displaying sample analysis results obtained by the above-described measuring operation. FIG. 14A and FIG. 14B are flow charts showing steps of the sample analysis result displaying operation. By operating the input unit 408 of the information processing unit 3, the operator can issue an instruction to display a job list screen for displaying a plurality of sample analysis results on a list. For example, by selecting, through a mouse click operation or the like, the icon C102 provided in the tool bar A101 of the quality control chart screen D100 (see FIG. 11), an instruction to display a job list screen is issued to the information processing unit 3. Upon receiving the instruction to display a job list screen (step S401), the CPU 401 of the information processing unit 3 reads data of sample analysis results registered in the analysis result data base DB2 (step S402), and causes the display unit 409 to display a job list screen (step S403).

FIG. 15 shows an example of the job list screen. Similarly to the quality control chart screen D100, a job list screen D400 is provided with the tool bar A101 in which a plurality of icons are arranged, in an upper area of the screen. The tool bar A101 is provided with the icons C102 to C105.

Further, similarly to the quality control chart screen D100, below the tool bar A101 of the job list screen D400, the work area A106 which accounts for a large portion of the job list screen D400 is provided. The work area A106 is provided with an analysis result table C401 in which a plurality of sample analysis results are listed. The analysis result table C401 is a table in which one analysis result is displayed in one line. The analysis result table C401 includes a column for indicating the measurement date, a column for indicating the measurement time, a column for indicating the sample rack number and its holding position in which the corresponding sample is held (indicated as “RACK NUMBER/POSITION” in FIG. 15), a column for indicating the sample ID (indicated as “SAMPLE NUMBER” in FIG. 15), and a plurality of columns for respectively indicating analysis results (numerical data) for measurement items. Each line of the analysis result table C401 can be selected through a mouse click operation or the like, and a selected line is displayed in a different color from that for lines not selected. In the example shown in FIG. 15, the uppermost line of the analysis result table C401 is selected.

Scroll buttons C402 and C403 for scrolling the display are provided to the right of and below the analysis result table C401, respectively.

A plurality of icons are arranged to the right of the scroll button C402. The icons include an icon C404 for displaying a detailed analysis result screen described below, and an icon C405 for confirming data. Each of the icons C404 and C405 can be selected through a mouse click operation or the like. When the icon C404 is selected while one of the lines of the analysis result table C401 is selected, the display is switched to a detailed analysis result screen indicating detailed information of the analysis result of the selected line. Moreover, when the icon C405 is selected while one of the lines of the analysis result table C401 is selected, approval (validation) of the analysis result of the selected line is performed. An operator having authority to perform approval of sample analysis results performs approval if he or she determines that the analysis result is appropriate. When the approval of an analysis result is performed, the user ID of the operator who performed the approval, that is, of the operator logging in at the time of the approval, is stored in the field F204 of the record of the approved analysis result in the analysis result data base DB2.

With reference back to FIG. 14A and FIG. 14B, description of the sample analysis result displaying operation will be continued. The CPU 401 determines whether an instruction to display detailed information of the sample analysis result as described above has been received (step S404). When the instruction to display detailed information of the sample analysis result has not been received (NO in step S404), the CPU 401 ends the processing. On the other hand, when the instruction to display detailed information of the sample analysis result has been received (YES in step S404), the CPU 401 reads data of the designated sample analysis result from the analysis result data base DB2 (step S405), and causes the display unit 409 to display a detailed analysis result screen (step S406).

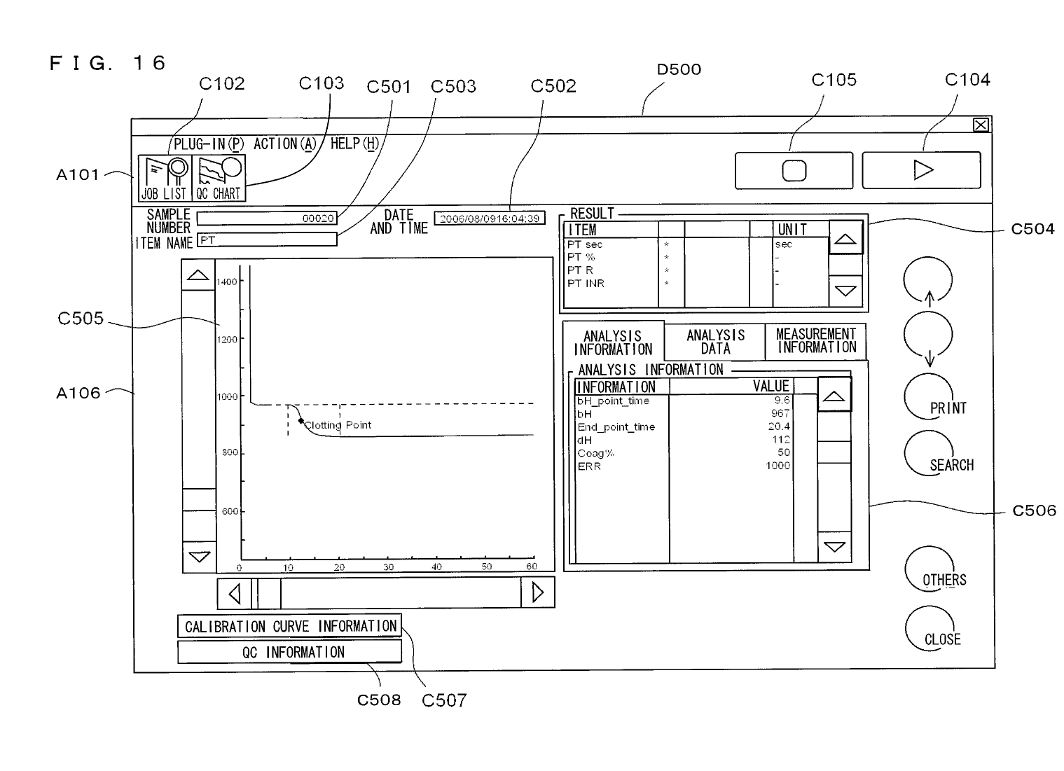

FIG. 16 shows an example of the detailed analysis result screen. Similarly to the quality control chart screen D100 and the job list screen D400, a detailed analysis result screen D500 is provided with the tool bar A101 in which a plurality of icons are arranged, in an upper area of the screen. The tool bar A101 is provided with the icon C102 to C105.

Further, similarly to the quality control chart screen D100 and the job list screen D400, below the tool bar A101 of the detailed analysis result screen D500, the work area A106 which accounts for a large portion of the detailed analysis result screen D500 is provided. Detailed information of the designated analysis result is shown in the work area A106. Specifically, a sample number C501, a measurement date and time C502, and a measurement item name C503 are displayed in an upper left portion of the work area A106 of the detailed analysis result screen D500. A numerical data display section C504 for displaying numerical data indicating the designated sample analysis result is provided to the right of the information C501 to C503, and a graph display section C505 for displaying a graph indicating the designated sample measurement data is provided below the information C501 to C503. A graph indicating, in time series, optical information of the sample detected by the detection unit 40 is displayed in the graph display section C505. That is, the horizontal axis of this graph is time, and the vertical axis of this graph is optical information (absorbance level).

An analysis related information display section C506 for displaying parameters used in the analysis of the measurement data and set values used in the measurement, and the like is provided below the numerical data display section C504 and to the right of the graph display section C505. A button C507 for causing a calibration curve information dialog D300 to be displayed, and a button C508 for causing a quality control information dialog D200 to be displayed are provided below the graph display section C505. Each of the buttons C507 and C508 can be selected through a mouse click operation or the like. When the button C507 is selected, a calibration curve information dialog D300 including detailed information of the calibration curve used in the sample analysis being displayed on the detailed analysis result screen D500 is called. When the button C508 is selected, a quality control information dialog D200 indicating a result of a quality control measurement performed immediately before the sample measurement being displayed on the detailed analysis result screen D500 is called. In the quality control information dialog D200, an analysis result of a measurement of a quality control specimen that was performed before and nearest to the time point when the sample measurement being displayed on the detailed analysis result screen D500 was performed is displayed. Accordingly, it is possible to determine whether the sample analyzer 1 which performed the above sample measurement was normally functioning, and thus, it is possible to verify the reliability of the sample analysis result.

A plurality of icons are arranged to the right of the numerical data display section C504 and the analysis related information display section C506. These icons include an icon for changing an analysis result to be displayed, an icon for printing the analysis result being displayed, and the like.

With reference back to FIG. 14A and FIG. 14B, description of the sample analysis result displaying operation will be continued. The CPU 401 determines whether an instruction to display detailed information of the calibration curve as described above has been received, that is, whether the button C507 has been selected (step S407). When the instruction to display detailed information of the calibration curve has been received (YES in step S407), the CPU 401 reads, from the calibration curve data base DB4, information of the calibration curve used in the sample analysis displayed on the detailed analysis result screen D500 (step S408). Specifically, a record having the same calibration curve ID as the calibration curve ID (data stored in the field F208 in the analysis result data base DB2) contained in the analysis result data being displayed on the detailed analysis result screen D500 is read from the calibration curve data base DB4. Further, the CPU 401 causes the display unit 409 to display a calibration curve information dialog, based on the read information (step S409). Since the configuration of the calibration curve information dialog is the same as that described above, description thereof will be omitted.

On the other hand, when the instruction to display detailed information of the calibration curve has not been received in step S407 (NO in step S407), the CPU 401 determines whether an instruction to display the analysis result of the quality control specimen as described above has been received, that is, whether the button C508 has been selected (step S410). When the instruction to display the analysis result of the quality control specimen has not been received (NO in step S410), the CPU 401 returns the processing to step S407. On the other hand, when an instruction to display the analysis result of the quality control specimen has been generated (YES in step S410), the CPU 401 reads, from the quality control data base DB3, analysis result data of a measurement of a quality control specimen that was performed before and nearest to the time point when the sample measurement being displayed on the detailed analysis result screen D500 was performed (step S411). In this process, the CPU 401 searches the quality control data base DB3 for a record that has the same measurement item as the measurement item (data stored in the field 202 in the analysis result data base DB2) contained in the analysis result data being displayed on the detailed analysis result screen D500, and that has a measurement date and a measurement time that is before and nearest to the measurement date and the measurement time (data stored in the fields F205 and F206 in the analysis result data base DB2) contained in the analysis result data; and reads the found record. When there are a plurality of analysis results having the same quality control specimen ID and the same measurement item as the quality control specimen ID and the measurement item contained in the record having the above-described latest measurement date and measurement time, all of such analysis results are read from the quality control data base DB3.

Further, the CPU 401 reads, from the reagent information data base DB1, reagent information of the reagent used in the measurement of the quality control specimen for obtaining the analysis result data read in step S411 (step S412). Specifically, of the analysis result data of the quality control specimen read in step S411, reagent information containing the same serial number as the reagent serial number contained in the analysis result data of the quality control specimen having the measurement date and measurement time before and nearest to the measurement date and measurement time of the analysis result being displayed on the detailed analysis result screen D500 is read from the reagent information data base DB1. That is, reagent information of the reagent used in the quality control measurement performed by the sample analyzer 1, which also performed the sample measurement being displayed on the detailed analysis result screen D500, is read from the reagent information data base DB1.

Next, the CPU 401 causes the display unit 409 to display a quality control information dialog, based on the analysis result of the quality control specimen and the reagent information read in the above described manner (step S413). In the quality control information dialog, the result of the quality control measurement performed by the sample analyzer 1, which performed the sample measurement being displayed on the detailed analysis result screen D500, and information (lot number, vial number, reagent preparer, elapsed time, and the like) for verifying the state of the reagent used in the quality control measurement are displayed. Since the configuration of the quality control information dialog is the same as that described above, description thereof will be omitted.

Next, the CPU 401 determines whether an instruction to display detailed information of the calibration curve has been received in the quality control information dialog, that is, the button C206 (see FIG. 12) has been selected (step S414). When the instruction to display detailed information of the calibration curve has not been received (NO in step S414), the CPU 401 advances the processing to step S415. On the other hand, when the instruction to display to detailed information of the calibration curve has been received (YES in step S414), the CPU 401 advances the processing to step S408, and reads, from the calibration curve data base DB4, information of the calibration curve used in the sample analysis being displayed on the detailed analysis result screen D500.

After performing the process of step S5409 to display a calibration curve information dialog, or when an instruction to display detailed information of the calibration curve has not been received in step S414 (NO in step S414), the CPU 401 determines whether an instruction not to display a dialog has been received (step S415). When the instruction not to display a dialog has not been received (NO in step S415), the CPU 401 performs the process of step S415 again. On the other hand, when the instruction not to display a dialog has been received (YES in step S415), the CPU 401 closes a corresponding one of the quality control information dialog D200 and the calibration curve information dialog D300 (step S416), and ends the processing.

By the sample analyzer according to the present embodiment having the above configuration, a result of a quality control measurement and information (such as lot number, vial number, reagent preparer, and elapsed time) for verifying the state of the reagent used in the quality control measurement are displayed in a quality control information dialog. Accordingly, when confirming a result of a quality control measurement, an operator can also confirm information for verifying the state of the reagent used in the quality control measurement. Accordingly, the operator can easily verify the state of the reagent used in the quality control measurement, and can easily examine whether variation in results of the quality control measurement is due to the reagent.

Further, in the sample analyzer 1 according to the present embodiment, an elapsed time from the time when a reagent was set in the measurement unit for the first time until the reagent was used in the quality control measurement is displayed in the quality control information dialog D200. Accordingly, the operator can easily understand the deterioration state of the reagent at the time of the performance of the quality control measurement. Further, the quality control chart C201, which is a time series graph of analysis results of a plurality of quality control measurements that were performed in the past, is displayed in the quality control information dialog D200. Therefore, the operator can easily understand the transition of the quality control results, and can confirm not only one analysis result of a quality control specimen but also analysis results before and after that analysis result.

Further, in the sample analyzer 1 according to the present embodiment, the user ID of the operator who performed the quality control measurement is displayed in the quality control information dialog D200. Accordingly, for example, when quality control results vary and are not stable, the operator who confirmed the quality control information dialog D200 can easily take measures, such as asking the operator who performed the quality control measurement about the condition, etc. at the time of the quality control measurement. Therefore, the operator can easily evaluate the reliability of the result of the quality control measurement.

### OTHER EMBODIMENTS

In the above embodiment, description has been given of the configuration for calling a quality control information dialog from the quality control chart screen when a detailed analysis result of a quality control specimen is to be displayed. However, the present invention is not limited thereto. By varying the display of the quality control chart screen, a detailed analysis result of a quality control specimen may be displayed. For example, when one of the quality control charts C107 to C109 is designated in the quality control chart screen D100, and an instruction to display detailed information of the quality control result is issued, quality control charts other than the designated quality control chart are no more displayed, and the designated quality control chart is moved to a specific position (for example, an uppermost portion of the work area A106) and the detailed information of the selected quality control result and the reagent information may be displayed in the now-vacant area.

Further, when one of analysis results of a quality control specimen (a point on the quality control chart) is selected in the quality control chart screen, reagent information (reagent information of the reagent used in the analysis of the quality control specimen) relating to the selected analysis result may be displayed on the quality control chart screen. At this time, detailed information of the selected analysis result may also be displayed in the quality control chart screen.

Further, in conjunction with results of quality control measurements, the user ID of the operator who set the reagent on the sample analyzer 1 may be displayed. Accordingly, when quality control results are not stable, an operator confirming the results of the quality control measurements can easily confirm the cause by asking the operator who set the reagent.

Further, in the embodiment described above, results of quality control measurements obtained by the measurement unit 2 and information of reagents used in the quality control measurements are stored in the hard disk 404 of the sample analyzer 1, and a quality control information dialog D200 is displayed based on information read from the hard disk 404. However, the present invention is not limited thereto. Results of quality control measurements obtained by the measurement unit 2 and information of reagents used in the quality control measurements are stored in an external server connected to the sample analyzer 1 through a network, and necessary information may be downloaded from the server when a quality control information dialog D200 is to be displayed.

Further, in the embodiment described above, the result of a quality control measurement and the reagent information for verifying the state of the reagent used in the quality control measurement are displayed by the instruction operated on the detailed analysis result screen. However, the present invention is not limited thereto. A detailed analysis result screen may include the result of a quality control measurement performed before obtainment of the measurement result and the reagent information for verifying the state of the reagent used in the quality control measurement.

Further, in the above embodiment, a configuration of the sample analyzer 1 being a blood coagulation measuring apparatus has been described. However, the present invention is not limited thereto. The sample analyzer may be a sample analyzer other than a blood coagulation measuring apparatus, such as a blood cell counter, an immune analyzer, a urine formed element analyzer, or a urine qualitative analyzer.

What is claimed is:

1. A sample analyzer comprising:
a measurement unit configured to perform, by using a reagent, a quality control measurement for measuring a quality control specimen;
a display; and
a controller configured to control the display to show reagent information for verifying a state of the reagent used in the quality control measurement, in conjunction with a result of the quality control measurement obtained by the measurement unit.

2. The sample analyzer of claim 1, further comprising a memory configured to store the result of the quality control measurement obtained by the measurement unit and information of the reagent used in the quality control measurement by the measurement unit, wherein
based on the information stored in the memory, the controller controls the display to show the reagent information for verifying the state of the reagent used in the quality control measurement, in conjunction with the result of the quality control measurement obtained by the measurement unit.

3. The sample analyzer of claim 1, wherein
the controller controls the display to show as the reagent information for verifying the state of the reagent used in the quality control measurement, an elapsed time from a time when the reagent used in the quality control measurement was placed in the measurement unit until the reagent was used in the quality control measurement.

4. The sample analyzer of claim 1, wherein
the controller controls the display to show as the reagent information for verifying the state of the reagent used in the quality control measurement, identification information of a container for reagent in which the reagent used in the quality control measurement was contained.

5. The sample analyzer of claim 4, wherein
the controller further controls the display to show as the reagent information for verifying the state of the reagent used in the quality control measurement, a lot number of the reagent used in the quality control measurement.

6. The sample analyzer of claim 1, wherein
the controller controls the display to show as the reagent information for verifying the state of the reagent used in the quality control measurement, a reagent preparer who prepared the reagent used in the quality control measurement.

7. The sample analyzer of claim 1, wherein
the controller is configured to:
control the display to show a quality control result screen in which measurement results of a plurality of quality control measurements performed in the past are shown in time series, and in which each of the measurement results is designatable; and
control, when a measurement result shown on the quality control result screen is designated, the display to show reagent information for verifying a state of a reagent used in a quality control measurement corresponding to the designated measurement result.

8. The sample analyzer of claim 1, wherein
the measurement unit is configured to perform quality control measurements for a plurality of measurement items, and
the controller is configured to:
control the display to show a quality control result screen in which results of the quality control measurements performed for the plurality of measurement items are shown, and in which each of the measurement items is designatable, and
control, when a measurement item shown on the quality control result screen is designated, the display to show reagent information for verifying a state of a reagent used in a quality control measurement performed for the designated measurement item.

9. The sample analyzer of claim 7, wherein
upon receiving a predetermined instruction through the quality control result screen, the controller controls the display to show information of a calibration curve used in the quality control measurement corresponding to the reagent information.

10. The sample analyzer of claim 9, wherein
the controller controls the display to show as the information of the calibration curve, information of a reagent used in measurement for generating the calibration curve.

11. The sample analyzer of claim 1, wherein
the controller further controls the display to show a placer who placed, in the measurement unit, the reagent used in the quality control measurement.

12. The sample analyzer of claim 1, wherein
the controller further controls the display to show a measurer who issued an instruction to perform the quality control measurement to the sample analyzer.

13. The sample analyzer of claim 1, wherein
the controller further controls the display to show information for verifying a state of the quality control specimen used in the quality control measurement.

14. The sample analyzer of claim 13, wherein
the controller controls the display to show as the information for verifying the state of the quality control specimen used in the quality control measurement, a lot number of the quality control specimen used in the quality control measurement.

15. The sample analyzer of claim 1, wherein
the measurement unit is configured to perform, by using the reagent, a sample measurement for measuring a sample of a subject, and
the controller is configured to:
control the display to show a sample measurement result screen including a measurement result of the sample of the subject measured by the measurement unit and the result of a quality control measurement performed before obtainment of the measurement result, in conjunction with the reagent information for verifying the state of the reagent used in the quality control measurement.

16. The sample analyzer of claim 15, wherein
the controller is configured to:
control the display to show a sample measurement result screen including a predetermined instruction section operable by a user; and
control, when the instruction section is operated, the display to show the result of a quality control measurement performed before obtainment of the measurement result being shown on the sample measurement result screen, in conjunction with the reagent information for verifying the state of the reagent used in the quality control measurement.

17. The sample analyzer of claim 15, wherein
the controller is configured to control the display to show as the result of the quality control measurement, a result of a quality control measurement performed immediately before the sample measurement being shown on the sample measurement result screen.

18. A sample analyzer comprising:
a measurement unit configured to perform, by using a reagent, a sample measurement for measuring a sample of a subject, and to perform, by using a reagent, a quality control measurement for measuring a quality control specimen;
a display; and
a controller configured to:
control the display to show a sample measurement result screen for showing a measurement result of the sample of the subject measured by the measurement unit, and
control, upon receiving a predetermined instruction through the sample measurement result screen, the display to show reagent information for verifying a state of a reagent used in a quality control measurement performed before obtainment of the measurement result being shown on the sample measurement result screen.

19. A sample analyzer comprising:
a measurement unit including a setting section in which a reagent container containing a liquid reagent prepared by diluting a freeze-dried reagent with a predetermined liquid is set, and configured to perform, by using the liquid reagent in the reagent container set in the setting section, a measurement of a quality control specimen;
a display; and
a controller configured to control the display to show a lot number of the reagent used in the measurement of the quality control specimen and identification information of the reagent container in which the liquid reagent was contained, in conjunction with a result of the measurement of the quality control specimen obtained by the measurement unit.

20. A non-transitory storage medium having stored therein computer-executable programs executed by at least one processor of a sample analyzer to:
obtain a measurement result of a quality control specimen measured by a measurement unit by using a reagent; and
show reagent information to a display for verifying a state of the reagent used in the measurement of the quality control specimen, in conjunction with the measurement result of the quality control specimen.

21. A non-transitory storage medium having stored therein computer-executable programs executed by at least one processor of a sample analyzer to:
obtain a measurement result of a sample of a subject measured by a measurement unit by using a reagent;
show a sample measurement result screen to a display for showing the measurement result of the sample; and
show, upon receiving a predetermined instruction through the sample measurement result screen, reagent information to the display for verifying a state of a reagent used in a measurement of a quality control specimen performed by the measurement unit before obtaining the measurement result being displayed on the sample measurement result screen.
